(19) United States
(12) Patent Application Publication
(10) Pub. No.: US 2019/0354887 A1
(43) Pub. Date: Nov. 21, 2019

(54) KNOWLEDGE GRAPH BASED LEARNING CONTENT GENERATION

(71) Applicant: ACCENTURE GLOBAL SOLUTIONS LIMITED, Dublin 4 (IE)

(72) Inventors: Venkatesh SUBRAMANIAN, Bangalore (IN); Kumar ABHINAV, Bangalore (IN); Alpana DUBEY, Bangalore (IN); Dana A. KOCH, St. Charles, IL (US); Divakaruni Aditya VENKAT, Hyderabad (IN); Sanjay PODDER, Thane (IN); Bruno MARRA, Antibes (FR)

(73) Assignee: ACCENTURE GLOBAL SOLUTIONS LIMITED, Dublin 4 (IE)

(21) Appl. No.: 15/984,246

(22) Filed: May 18, 2018

(51) Int. Cl. G06N 5/04; G06F 17/30; G09B 5/06

(52) U.S. Cl. CPC G06N 5/048; G09B 7/00; G09B 5/065; G06F 17/30958

(57) ABSTRACT

According to an example, with respect to knowledge graph based learning content generation, a plurality of concepts may be extracted from a plurality of documents. A word embedding similarity, and pointwise mutual information may be determined between each concept of the plurality of concepts. A concept similarity may be determined between each concept of the plurality of concepts, and a plurality of concept pairs that include similar concepts may be identified. A relationship may be determined between concepts for each concept pair of the plurality of concept pairs, and a determination may be made as to whether a concept of a concept pair is a pre-requisite of another concept of the concept pair to generate a knowledge graph. Based on the knowledge graph, a plurality of attributes and a learning goal for a learner, a concept of the plurality of concepts that matches the learning goal may be determined.

### BACKGROUND

In environments such as learning, hiring, and other such environments, a user may select from a plurality of available options to meet the user's learning needs. For example, in a learning environment, a user may identify a topic for learning, and select a course that may or may not provide adequate learning on the topic. Once the user has completed the selected course, the user may identify other topics for learning and similarly pursue other courses that may or may not provide adequate learning on the other topics. In this manner, the user may attempt to learn topics to meet the user's learning needs.

### BRIEF DESCRIPTION OF DRAWINGS

Features of the present disclosure are illustrated by way of examples shown in the following figures. In the following figures, like numerals indicate like elements, in which

FIG. 1 illustrates an architecture of a knowledge graph based learning content generation system, according to an example of the present disclosure;

FIG. 2 illustrates concept extraction to illustrate operation of the knowledge graph based learning content generation system of FIG. 1, according to an example of the present disclosure;

FIG. 3 illustrates distributed word vector embedding to illustrate operation of the knowledge graph based learning content generation system of FIG. 1, according to an example of the present disclosure;

FIG. 4 illustrates concept similarity determination to illustrate operation of the knowledge graph based learning content generation system of FIG. 1, according to an example of the present disclosure;

FIG. 5 illustrates word embedding and pointwise mutual information examples to illustrate operation of the knowledge graph based learning content generation system of FIG. 1, according to an example of the present disclosure;

FIG. 6 illustrates relation learning to illustrate operation of the knowledge graph based learning content generation system of FIG. 1, according to an example of the present disclosure;

FIG. 7 illustrates a knowledge graph example to illustrate operation of the knowledge graph based learning content generation system of FIG. 1, according to an example of the present disclosure;

FIG. 8 illustrates another knowledge graph example to illustrate operation of the knowledge graph based learning content generation system of FIG. 1, according to an example of the present disclosure;

FIG. 9 illustrates a learning recommendation flowchart of the knowledge graph based learning content generation system of FIG. 1, according to an example of the present disclosure;

FIG. 10 illustrates a learner's journey map to illustrate operation of the knowledge graph based learning content generation system of FIG. 1, according to an example of the present disclosure;

FIG. 11 illustrates a block diagram for knowledge graph based learning content generation, according to an example of the present disclosure;

FIG. 12 illustrates a flowchart of a method for implementing a knowledge graph based learning content generation, according to an example of the present disclosure; and

FIG. 13 illustrates a further block diagram for knowledge graph based learning content generation, according to an example of the present disclosure.

### DETAILED DESCRIPTION

For simplicity and illustrative purposes, the present disclosure is described by referring mainly to examples thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Knowledge graph based learning content generation systems, methods for implementing a knowledge graph based learning content generation, and non-transitory computer readable media having stored thereon machine readable instructions for knowledge graph based learning content generation are disclosed herein. The systems, methods, and non-transitory computer readable media disclosed herein provide for the generation of a knowledge graph, and the matching, based on the generated knowledge graph, of a learner to learning material.

In the field of content learning, there is an infinite amount of learning material that may be utilized by a learner to ascertain learning content to match the learner's needs. In this regard, when a learner is searching for content, the learner may spend an inordinate amount of time searching for the correct content to match the learner's needs.

In other fields such as job creation, the relationship between skills and requirements may be relevant to identify applicants that match a job description.

With respect to content learning, job matching, and other such fields, it is technically challenging to help a learner, recruiter, or other such users to identify the correct concepts that match a learner's learning needs, the correct skills that match a recruiter's hiring needs, etc. Further, it is technically challenging to incorporate a user's technical attributes, such as location, movement, time of usage, etc., to match learning needs, hiring needs, etc.

In order to address at least the aforementioned technical challenges with respect to content learning, job matching, and other such fields, the systems, methods, and non-transitory computer readable media disclosed herein provide a machine learning based approach to provide a learner with recommendations on learning content to match the learner's needs. In this regard, the systems, methods, and non-transitory computer readable media disclosed herein implement a hybrid model, and utilize the concept of context awareness of a learner, as well as microlearning based on neuroscience principles to provide a learner with recommendations on learning content to match the learner's needs. The systems, methods, and non-transitory computer readable media disclosed herein further implement an automated approach to identify skills and concepts, and a knowledge graph to facilitate identification of semantic and structural relations between skills and concepts.

The knowledge graph may be utilized in various domains such as learning and development, organization hiring, hiring freelancers in crowdsourcing, and other such fields.

According to examples described herein, the systems, methods, and non-transitory computer readable media disclosed herein may generate personalized recommendations with respect to concepts in which the learner's performance is to be improved.

According to other examples described herein, the systems, methods, and non-transitory computer readable media disclosed herein may generate personalized recommendations with respect to new concepts in which a learner may be interested.

According to further examples described herein, the systems, methods, and non-transitory computer readable media disclosed herein may generate personalized recommendations with respect to concepts which other similar learners are opting for.

According to examples described herein, the systems, methods, and non-transitory computer readable media disclosed herein may utilize a rich set of data in order to make recommendations. In the context of learning, examples of the data may include a learner's history that includes courses that have been registered for and completed, learning patterns for the learner, etc. Other examples of the data may include a concept mapping knowledge graph, course content, and context information such as location, time, etc.

According to examples described herein, the systems, methods, and non-transitory computer readable media disclosed herein may for provide the reasoning for each of the output recommendations, for example, with respect to learning content.

According to examples described herein, the systems, methods, and non-transitory computer readable media disclosed herein may provide for greater efficiency for learners to identify the correct content.

According to examples described herein, the systems, methods, and non-transitory computer readable media disclosed herein provide for identification of the content related to the area where a learner needs to improve, and also new concepts that the learner may be interested in.

According to examples described herein, the systems, methods, and non-transitory computer readable media disclosed herein provide for the identification of learning trends that similar communities or groups are following.

According to examples described herein, the systems, methods, and non-transitory computer readable media disclosed herein provide for the generation of a knowledge graph using sources such as Wikipedia, and other such sources.

According to examples described herein, the systems, methods, and non-transitory computer readable media disclosed herein provide for the generation, based on the knowledge graph, of a personalized recommendation to a learner with respect to a new concept the learner may be interested in.

According to examples described herein, the systems, methods, and non-transitory computer readable media disclosed herein provide for the identification, based on the knowledge graph, of concepts in which the learner's performance may need improvement.

According to examples described herein, the systems, methods, and non-transitory computer readable media disclosed herein provide for the identification, based on the knowledge graph, of concepts that other similar learners may be interested in.

In some examples, elements of the knowledge graph based learning content generation system may be machine readable instructions stored on a non-transitory computer readable medium. In this regard, the knowledge graph based learning content generation system may include or be a non-transitory computer readable medium. In some examples, the elements of the knowledge graph based learning content generation system may be hardware or a combination of machine readable instructions and hardware.

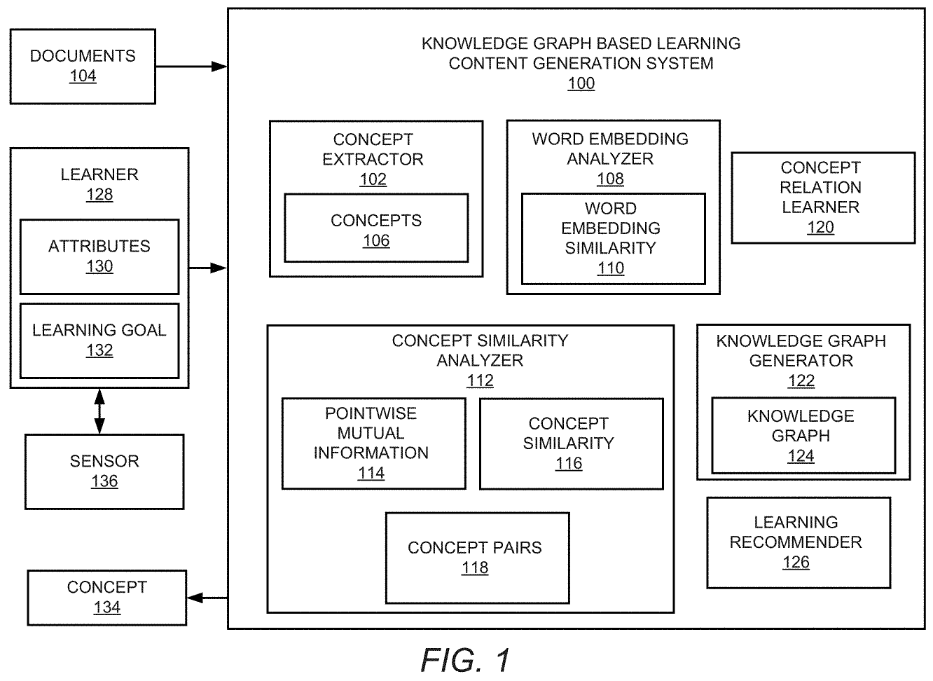

FIG. 1 illustrates an architecture of a knowledge graph based learning content generation system 100 (hereinafter “system 100”), according to an example of the present disclosure.

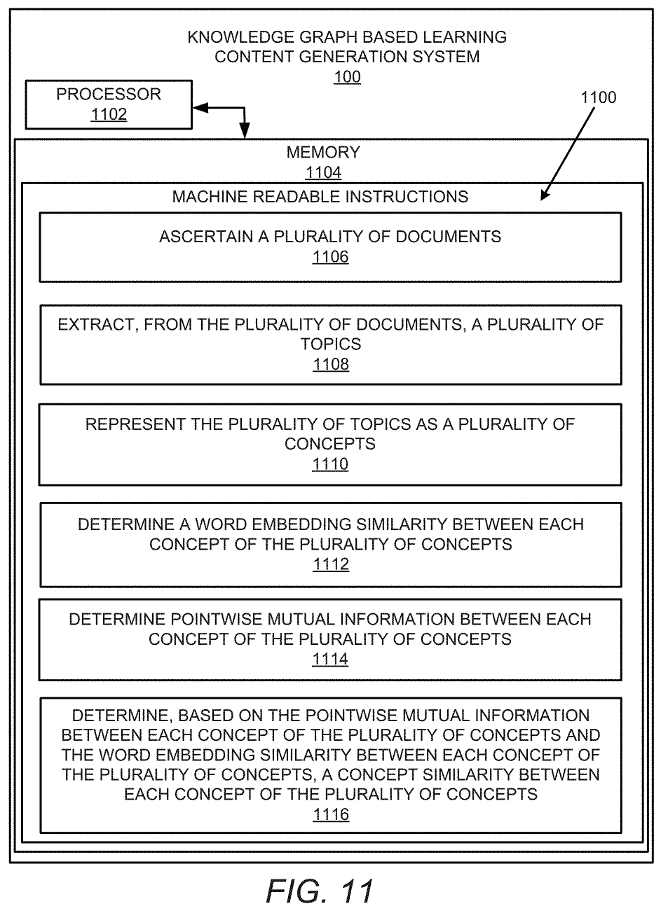

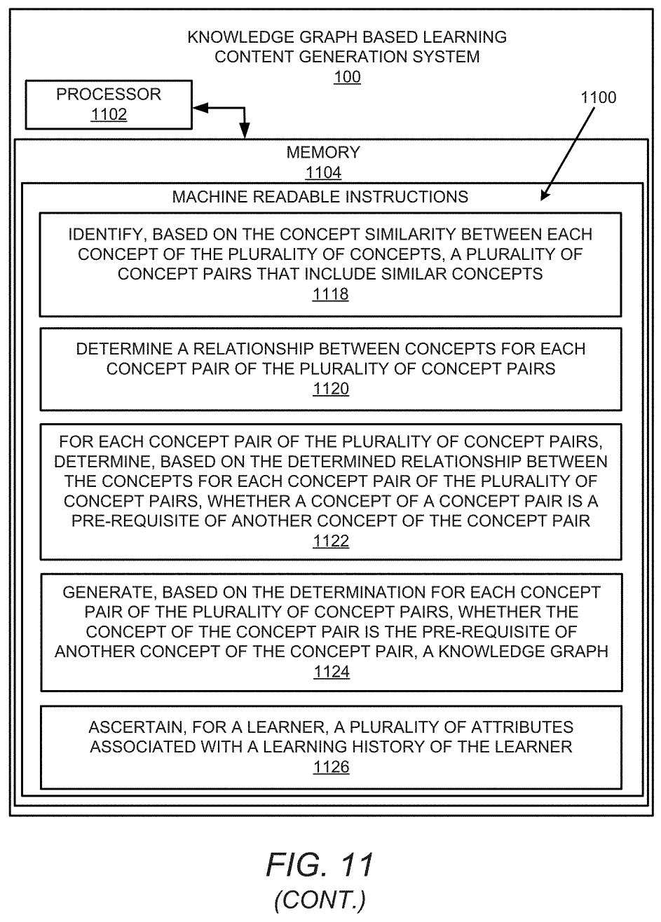

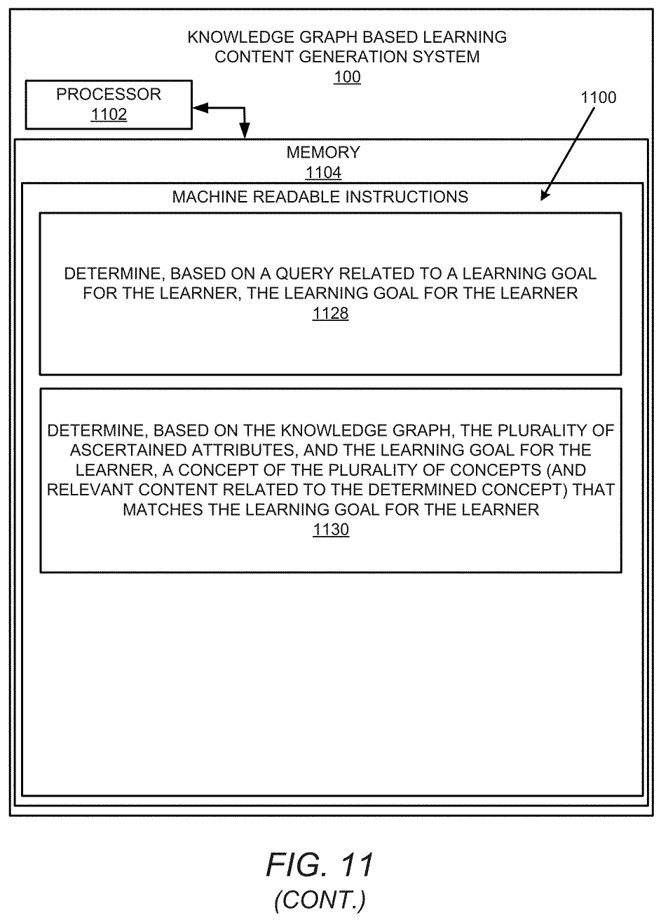

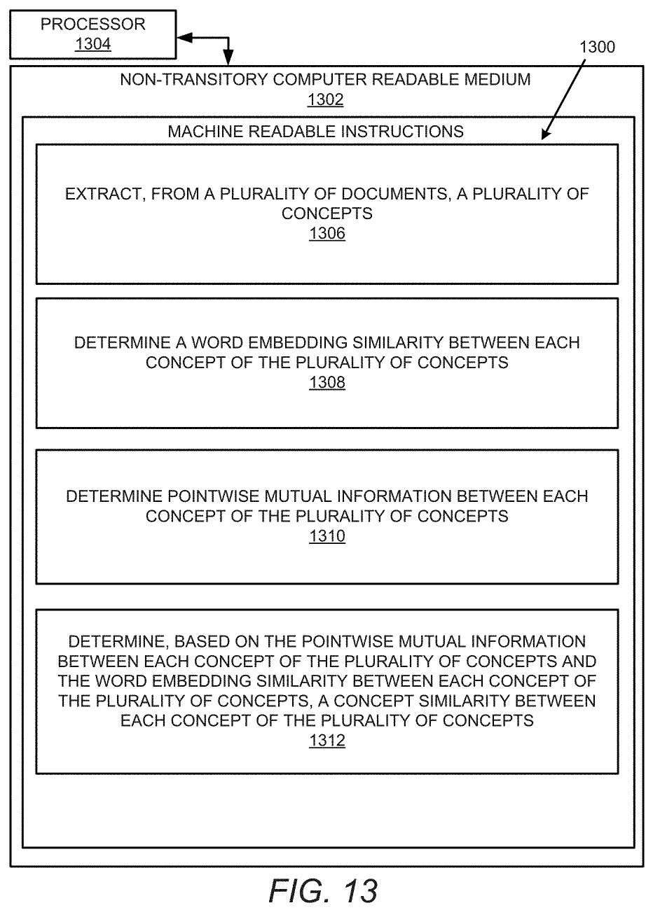

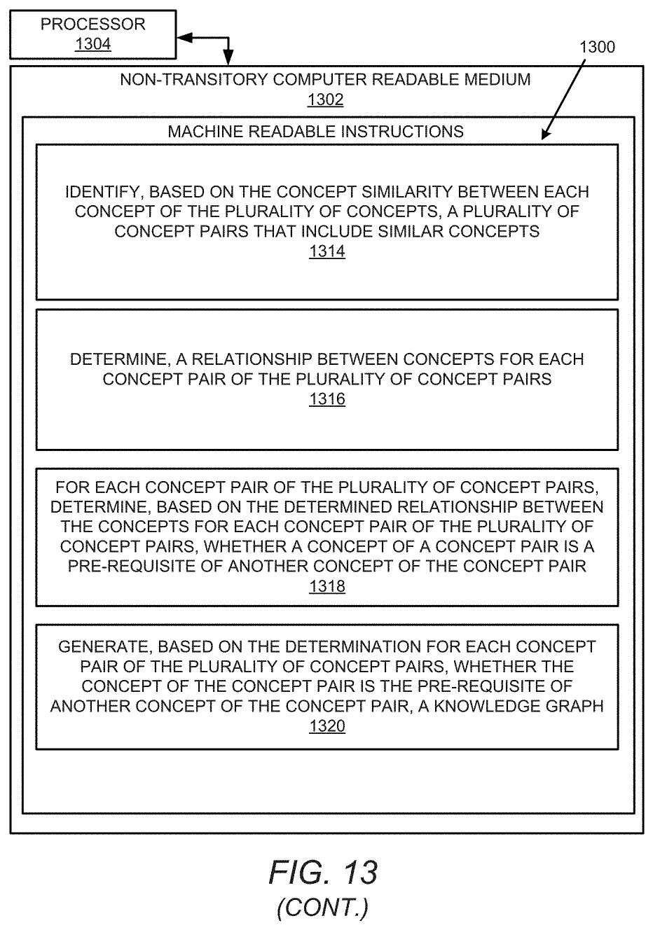

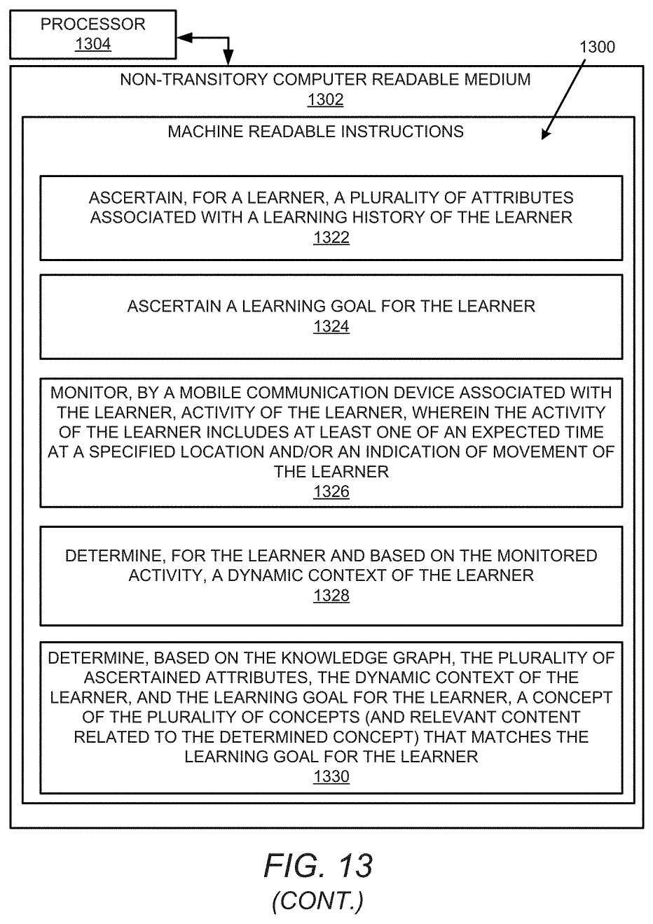

Referring to FIG. 1, the system 100 may include a concept extractor 102 that is executed by at least one hardware processor (e.g., the hardware processor 1102 of FIG. 11, and/or the hardware processor 1304 of FIG. 13) to ascertain a plurality of documents 104. Further, the concept extractor 102 may extract, from the plurality of documents 104, a plurality of topics, and represent the plurality of topics as a plurality of concepts 106.

A word embedding analyzer 108 that is executed by the at least one hardware processor (e.g., the hardware processor 1102 of FIG. 11, and/or the hardware processor 1304 of FIG. 13) may determine a word embedding similarity 110 (e.g., word2vec, GLOVE, etc.) between each concept of the plurality of concepts 106. In this regard, word embedding may provide for mapping of words or phrases from a vocabulary to vectors of real numbers.

According to examples, the word embedding analyzer 108 may determine the word embedding similarity 110 between each concept of the plurality of concepts 106 by determining a cosine similarity between each concept of the plurality of concepts 106.

A concept similarity analyzer 112 that is executed by the at least one hardware processor (e.g., the hardware processor 1102 of FIG. 11, and/or the hardware processor 1304 of FIG. 13) may determine pointwise mutual information 114 between each concept of the plurality of concepts 106. The concept similarity analyzer 112 may determine, based on the pointwise mutual information 114 between each concept of the plurality of concepts 106 and the word embedding similarity 110 between each concept of the plurality of concepts 106, a concept similarity 116 between each concept of the plurality of concepts 106. Further, the concept similarity analyzer 112 may identify, based on the concept similarity 116 between each concept of the plurality of concepts 106, a plurality of concept pairs 118 that include similar concepts.

According to examples described herein, the concept similarity analyzer 112 may identify, based on the concept similarity 116 between each concept of the plurality of concepts 106, the plurality of concept pairs 118 that include similar concepts by identifying the plurality of concept pairs 118 that include a pointwise mutual information score and a word embedding similarity score that exceeds a predetermined concept similarity threshold. For example, the predetermined concept similarity threshold may be specified at 0.40, with a range of the pointwise mutual information score and the word embedding similarity score being between 0 and 1.

A concept relation learner 120 that is executed by the at least one hardware processor (e.g., the hardware processor 1102 of FIG. 11, and/or the hardware processor 1304 of FIG. 13) may determine a relationship between concepts for each concept pair of the plurality of concept pairs 118. For each concept pair of the plurality of concept pairs, the concept relation learner 120 may determine, based on the determined relationship between the concepts for each concept pair of the plurality of concept pairs 118, whether a concept of a concept pair is a pre-requisite of another concept of the concept pair.

According to examples described herein, the concept relation learner 120 may determine, based on the determined relationship between the concepts for each concept pair of the plurality of concept pairs 118, whether the concept of the concept pair is the pre-requisite of another concept of the concept pair by determining a relevance score of the concept of the concept pair to contents associated with the another concept of the concept pair, determining another relevance score of the another concept of the concept pair to contents associated with the concept of the concept pair, and comparing the relevance scores to determine whether the concept of the concept pair is the pre-requisite of the another concept of the concept pair.

According to examples described herein, the concept relation learner 120 may determine, based on the determined relationship between the concepts for each concept pair of the plurality of concept pairs 118, whether the concept of the concept pair is the pre-requisite of another concept of the concept pair by determining a number of times that the concept of the concept pair is selected before the another concept of the concept pair, and based on a determination that the number of times that the concept of the concept pair is selected before the another concept of the concept pair exceeds a specified threshold, designating the concept of the concept pair as the pre-requisite of the another concept of the concept pair.

A knowledge graph generator 122 that is executed by the at least one hardware processor (e.g., the hardware processor 1102 of FIG. 11, and/or the hardware processor 1304 of FIG. 13) may generate, based on the determination for each concept pair of the plurality of concept pairs 118, whether the concept of the concept pair is the pre-requisite of another concept of the concept pair, a knowledge graph 124.

According to examples described herein, the knowledge graph generator 122 may generate, based on the determination for each concept pair of the plurality of concept pairs 118, whether the concept of the concept pair is the pre-requisite of another concept of the concept pair, the knowledge graph 124 by, for each course of a plurality of courses, adding each concept of the course of the plurality of courses as vertices of the knowledge graph 124. Further, the knowledge graph generator 122 may add each pre-requisite concept of the course of the plurality of courses as further vertices of the knowledge graph 124. The knowledge graph generator 122 may determine whether a concept similarity of a concept relative to a pre-requisite concept exceeds a specified concept similarity threshold, and based on a determination that the concept similarity of the concept relative to the pre-requisite concept exceeds the specified concept similarity threshold, add a directed edge from the pre-requisite concept to the concept associated with the pre-requisite concept.

A learning recommender 126 that is executed by the at least one hardware processor (e.g., the hardware processor 1102 of FIG. 11, and/or the hardware processor 1304 of FIG. 13) may ascertain, for a learner 128, a plurality of attributes 130 associated with a learning history of the learner 128. According to examples, the plurality of attributes 130 may include courses that the learner 128 has taken. The learning recommender 126 may determine, based on a query related to a learning goal for the learner, the learning goal 132 for the learner 128. The learning recommender 126 may determine, based on the knowledge graph 124, the plurality of ascertained attributes 130, and the learning goal 132 for the learner 128, a concept 134 of Michigan checked the plurality of concepts 106 (as well as the learning content) that matches the learning goal 132 for the learner 128.

According to examples described herein, the learning goal 132 for the learner 128 may include learning improvement, and the learning recommender 126 may determine, based on the knowledge graph 124, the plurality of ascertained attributes 130, and the learning goal 132 for the learner 128, the concept 134 of the plurality of concepts 106 that matches the learning goal 132 for the learner by identifying, for a specified time period, the concept 134 of the plurality of concepts 106 (as well as the learning content) for which a learner performance score is less than a specified performance threshold, and identifying the concept 134 of the plurality of concepts 106 for which the learner performance score is less than the specified performance threshold as the concept 134 of the plurality of concepts 106 that matches the learning goal 132 for the learner 128.

According to examples described herein, the learning goal 132 for the learner 128 may include anticipated learning, and the learning recommender 126 may determine, based on the knowledge graph 124, the plurality of ascertained attributes 130, and the learning goal 132 for the learner 128, the concept 134 of the plurality of concepts 106 that matches the learning goal 132 for the learner 128 by identifying the concept 134 of the plurality of concepts 106 that maps to a current learning status of the learner 128, and identifying, based on the knowledge graph 124, a next concept further to the identified concept of the plurality of concepts 106 that maps to the current learning status of the learner 128.

According to examples described herein, the learning goal 132 for the learner 128 may include anticipated learning, and the learning recommender 126 may determine, based on the knowledge graph 124, the plurality of ascertained attributes 130, and the learning goal 132 for the learner 128, the concept 134 of the plurality of concepts 106 that matches the learning goal 132 for the learner 128 by identifying the concept 134 of the plurality of concepts 106 that maps to a current learning status of the learner 128, and identifying, based on the knowledge graph 124, a shortest path to a further concept further to the identified concept of the plurality of concepts 106 that maps to the current learning status of the learner 128.

According to examples described herein, the learning recommender 126 may determine a learner to learner similarity between the learner 128 and another learner by applying, for example, Latent Dirichlet Allocation to a description of courses completed by the learner 128 and the another learner to generate description topics vectors, and determining a cosine similarity between the description topics vectors of the learner 128 and the another learner. Further, the learning recommender 126 may apply Latent Dirichlet Allocation to a profile overview of the learner 128 and the another learner to generate profile overview topics vectors, and determine a cosine similarity between the profile overview topics vectors of the learner 128 and the another learner. Further, the learning recommender 126 may determine a skills and concepts similarity between the learner 128 and the another learner. Further, the learning recommender 126 may apply Latent Dirichlet Allocation to a description of courses enrolled by the learner 128 and the another learner to generate course description topics vectors, and determine a cosine similarity between the course description topics vectors of the learner 128 and the another learner. Based on the foregoing, the learning recommender 126 may determine a learner to learner similarity score as a function of the determined cosine similarity between the description topics vectors of the learner 128 and the another learner, the determined cosine similarity between the profile overview topics vectors of the learner 128 and the another learner, the determined skills and concepts similarity between the learner 128 and the another learner, and the determined cosine similarity between the course description topics vectors of the learner 128 and the another learner.

According to examples described herein, the learning recommender 126 may identify a portion of the concept 134 of the plurality of concepts 106 that matches the learning goal for the learner 128 by dividing the concept into a plurality of frames, and performing a maximum sum sub-sequence process to identify a relevant frame of the plurality of frames that matches the learning goal 132 for the learner 128.

According to examples described herein, the system 100 may include a sensor 136 to monitor activity of the learner 128. In this regard, the learning recommender 126 may determine, for the learner 128 and based on the monitored activity, a dynamic context of the learner 128, and determine, based on the knowledge graph 124, the plurality of ascertained attributes 130, the determined dynamic context of the learner 128, and the learning goal 132 for the learner 128, the concept 134 of the plurality of concepts 106 that matches the learning goal 132 for the learner 128.

According to examples described herein, the sensor 136 may monitor activity of the learner 128. In this regard, the learning recommender 126 may determine, for the learner 128 and based on the monitored activity, a dynamic context of the learner 128, and determine, based on the knowledge graph 124, the plurality of ascertained attributes 130, the dynamic context of the learner 128, and the learning goal 132 for the learner 128, a concept 134 of the plurality of concepts 106 that matches the learning goal 132 for the learner 128.

According to examples described herein, the sensor 136 may include a location sensor, and the activity of the learner 128 may include an expected time at a specified location. In this regard, the learning recommender 126 may determine, based on the knowledge graph 124, the plurality of ascertained attributes 130, the dynamic context of the learner 128 that includes the expected time at the specified location, and the learning goal 132 for the learner 128, the concept 134 of the plurality of concepts 106 that matches the learning goal 132 for the learner 128 within the expected time at the specified location.

According to examples described herein, the sensor 136 may include a time sensor. In this regard, the sensor may monitor the activity of the learner 128 at a specified time. Further, the learning recommender 126 may determine, based on the knowledge graph 124, the plurality of ascertained attributes 130, the dynamic context of the learner 128 that includes the activity of the learner 128 at the specified time, and the learning goal 132 for the learner 128, the concept 134 of the plurality of concepts 106 that matches the learning goal 132 for the learner 128 at the specified time.

According to examples described herein, the sensor 136 may include a movement sensor, and the activity of the learner 128 may include an indication of movement of the learner 128. In this regard, the learning recommender 126 may determine, based on the knowledge graph 124, the plurality of ascertained attributes 130, the dynamic context of the learner 128 that includes the activity of the learner 128 that includes the indication of movement of the learner 128, and the learning goal 132 for the learner 128, the concept 134 of the plurality of concepts 106 that matches the learning goal 132 for the learner 128 during the movement of the learner 128.

Operation of the components of the system 100 is described in further detail with reference to FIGS. 1-10.

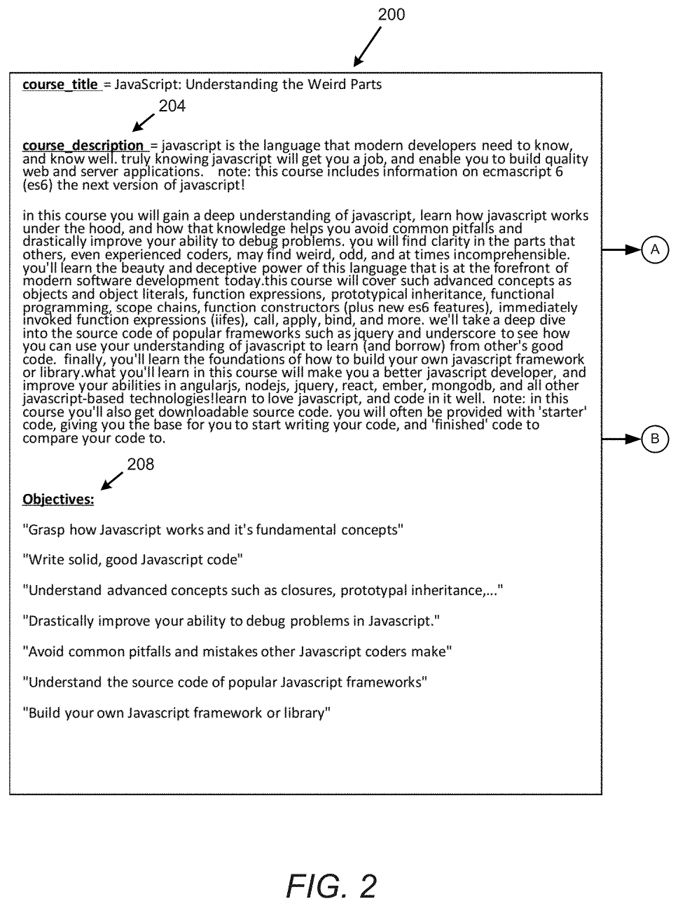

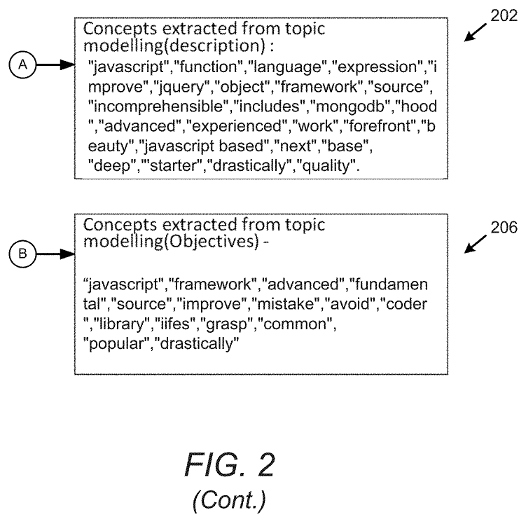

FIG. 2 illustrates concept are you feeling okay a a feeling okay otherwise hello extraction to illustrate operation of the system 100, according to an example of the present disclosure.

Referring to FIG. 2, with respect to concept extraction, the concept extractor 102 may implement Latent Dirichlet Allocation, and other such techniques, to extract topics from course content. The extracted topics may be represented as concepts. That is, the contents of each course may be represented as concepts. Different course contents as disclosed herein may also be referred to as a collection of documents 104.

For example, the concept extractor 102 may apply Latent Dirichlet Allocation to a course 200 to extract topics. As shown in 202, concepts extracted from topic modeling with respect to the description at 204 may include, for example, “javaScript”, “function”, “language”, etc. As shown in 206, concepts extracted from topic modeling with respect to objectives at 208 may include, for example, “javaScript”, “framework”, “advanced”, etc.

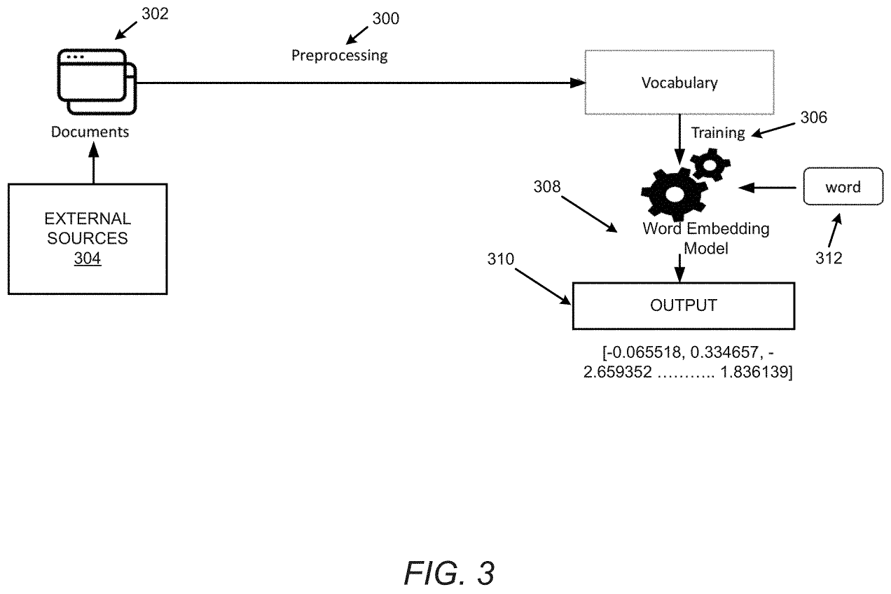

FIG. 3 illustrates distributed word vector embedding to illustrate operation of the system 100, according to an example of the present disclosure.

Referring to FIG. 3, with respect to distributed word vector embedding, the word embedding analyzer 108 may determine a word embedding relationship based on the principle that words which are similar in context appear closer in word embedding space. In this regard, at 300, the word embedding analyzer 108 may preprocess a document at 302, for example, for tokenization, stop words removal, and stemming. The document (e.g., one of the documents 104) may be determined from data ascertained from various external sources 304, where the data may be converted into a document. Examples of sources may include social media sources such as YOUTUBE, public websites such as WIKIPEDIA, educational sites, and other such sources. At 306, the word embedding analyzer 108 may train a word embedding model shown at 308. At 310, for a word received at 312, the word embedding analyzer 108 may infer a vector using the trained model. In this regard, the word embedding analyzer 108 may determine similarity between words using the trained model. According to an example, for the word “python” received at 312, an output vector may be represented as [−0.065518, 0.334657, −2.659352 . . . 1.836139].

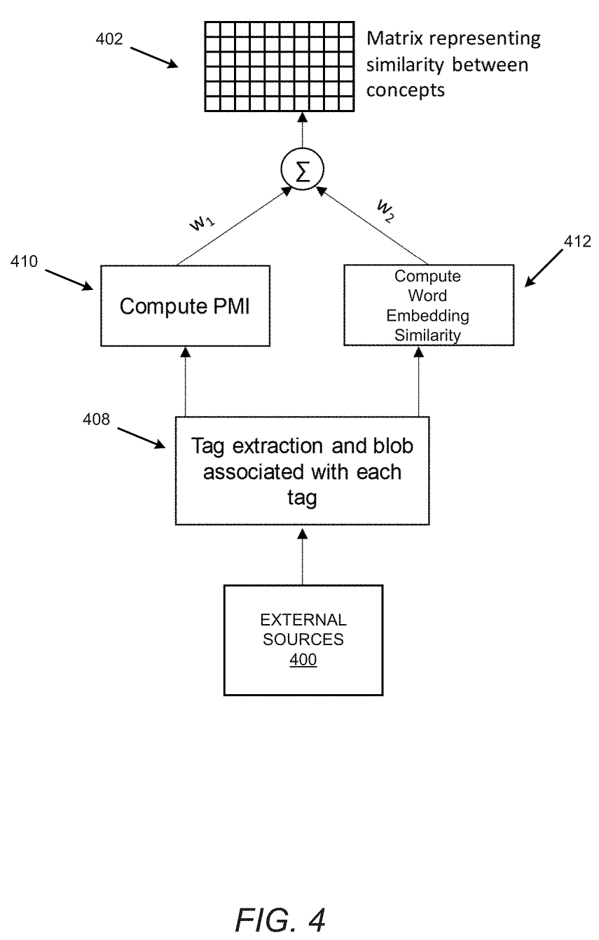

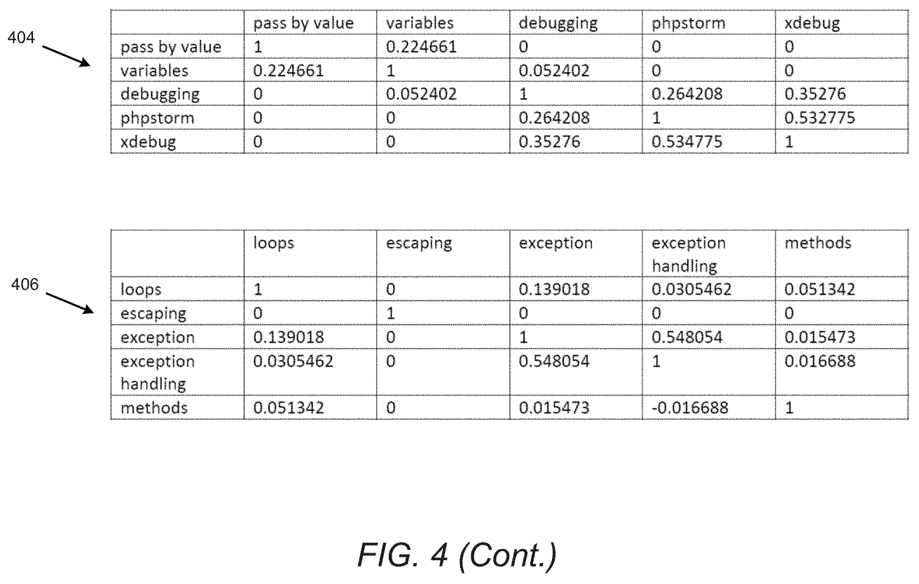

FIG. 4 illustrates concept similarity determination to illustrate operation of the system 100, according to an example of the present disclosure.

As disclosed herein with reference to FIG. 1, the concept similarity analyzer 112 may determine, based on the pointwise mutual information 114 between each concept of the plurality of concepts 106 and the word embedding similarity 110 between each concept of the plurality of concepts 106, a concept similarity 116 between each concept of the plurality of concepts 106. Further, the concept similarity analyzer 112 may identify, based on the concept similarity 116 between each concept of the plurality of concepts 106, a plurality of concept pairs 118 that include similar concepts. In this regard, referring to FIG. 4, with respect to concept similarity determination, the concept similarity analyzer 112 may apply pointwise mutual information (PMI), and other such techniques, to measure the semantic relatedness between two concepts to determine how likely the two concepts are to occur together. An input to the concept similarity analyzer 112 may include data fetched from external sources 400 such as STACKEXCHANGE, RESEARCHGATE, crowdsourcing platforms (e.g., UPWORK, FREELANCER, etc.), question and answer sites, and other such external sources. An output of the concept similarity analyzer 112 may include a matrix at 402 representing the semantic relatedness between concepts. Examples of the matrix at 402 are shown at 404 and 406. At 408, the concept similarity analyzer 112 may extract tags and a blob associated with each question posted on the external sources 400. A blob may be described as a textual description of a tag. For example if the tag is “Java”, then textual information about Java would be considered as a blob. The tags may be referred as concepts as disclosed herein. At 410, the concept similarity analyzer 112 may determine the pointwise mutual information between each concept. At 412, the concept similarity analyzer 112 may perform text processing that may include tokenization, stemming and lemmatization on the blob data, and may further determine the cosine similarity (e.g., word embedding processed) between each concept using pre-processed blob information. In this regard, the concept similarity analyzer 112 may determine concept similarity between concepts c1 and c2 as follows:

concept_sim(c1,c2)=w1*PMI(c1,c2)+w2*word2vec_sim(c1,c2) Equation (1)

For Equation (1), w1 may represent a weight assigned to the pointwise mutual information metric, and w2 may represent a weight assigned to the word embedding metric for any two concepts c1 and c2. By default, values of w1 and w2 may be set to 1. However, different weights may be assigned to these two metrics based on their outcomes. The word2vec_sim(c1, c2) may represent a cosine similarity between concepts vector c1 and c2.

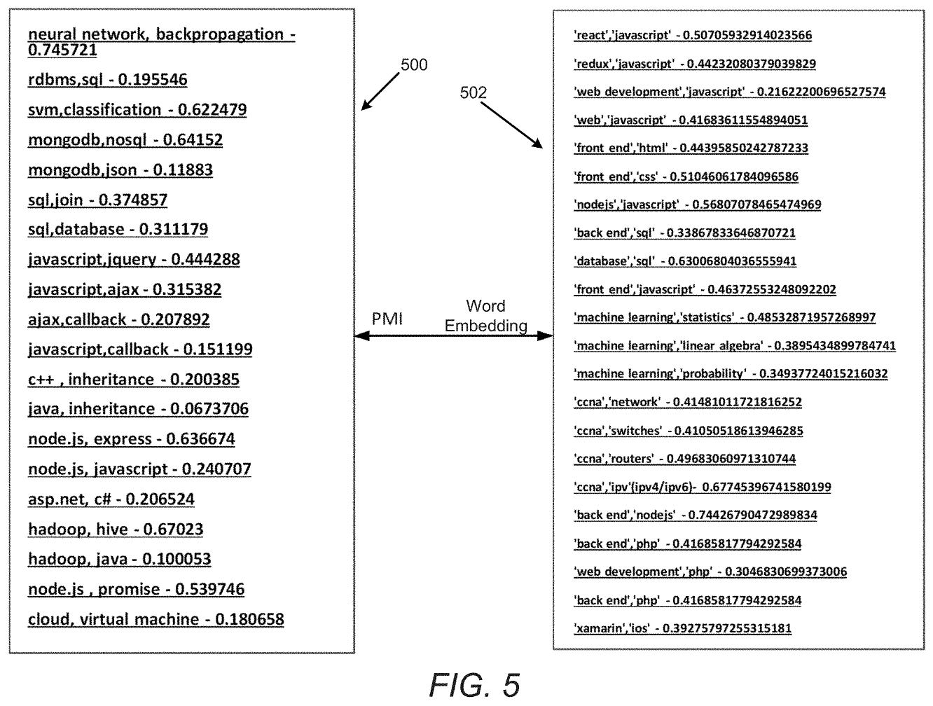

FIG. 5 illustrates word embedding and pointwise mutual information examples to illustrate operation of the system 100, according to an example of the present disclosure.

Referring to FIG. 5, examples of pointwise mutual information determination between various concepts such as “neural network” and “back propagation” equal to 0.745721, “rdbms” and “sql” equal to 0.195546, etc., are shown at 500. Examples of word embedding similarity between various concepts such as “react” and “JavaScript” equal to 0.50705932914023566, “REDUX” and “JavaScript” equal to 0.44232080379039829, etc., are shown at 502. The pointwise mutual information values and the word embedding similarity values may range from 0 to 1. A value closer to zero may indicate that the relationship between two concepts is weaker, whereas a value closer to one may indicate a stronger relationship between two concepts. In this regard, as disclosed herein, the concept similarity analyzer 112 may identify, based on the concept similarity 116 between each concept of the plurality of concepts 106, the plurality of concept pairs 118 that include similar concepts by identifying the plurality of concept pairs 118 that include a pointwise mutual information score and a word embedding similarity score that exceeds a predetermined concept similarity threshold. For example, the predetermined concept similarity threshold may be specified at 0.40, with a range of the pointwise mutual information score and the word embedding similarity score being between 0 and 1. The concept similarity threshold may provide for removal of concepts (extracted from topic modeling) which are not relevant. These removed concepts may not be considered as nodes in the knowledge graph, and thus provide for reduction of the dimensionality of the knowledge graph.

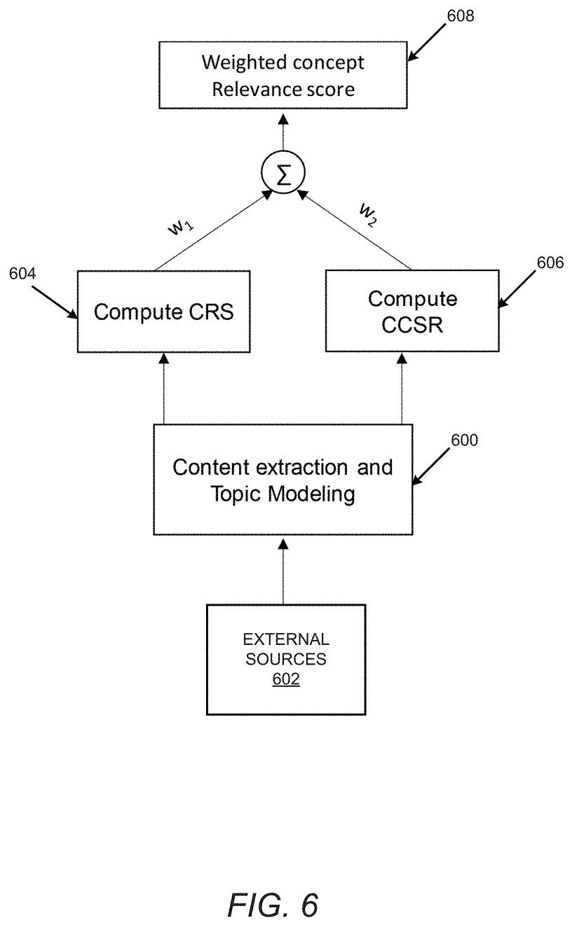

FIG. 6 illustrates relation learning to illustrate operation of the system 100, according to an example of the present disclosure.

Referring to FIG. 6, the concept relation learner 120 may learn the relationship between concepts. In this regard the concept relation learner 120 may determine how two concepts are related (e.g., whether a concept is a pre-requisite of another concept). The learned relationship may be used by the knowledge graph generator 122 to generate the knowledge graph 124. An input to the concept relation learner 120 may include content and course information represented as topics. An output of the content relation learner 128 may include a relationship between concept pairs (in pre-requisites form). At 600, the concept relation learner 120 may ascertain content and course information represented as topics from external sources 602, such as WIKIPEDIA, and other such sources. At 604, in order to determine the concept relevance score (CRS) for each ordered concept pairs (cᵢ, cⱼ), the content relation learner 128 may identify the contents Cⱼ relevance for concept cⱼ. The content relation learner 128 may determine the relevance of concept cᵢ in contents Cⱼ utilizing (Equation 2) and concept cⱼ in contents Cᵢ (Equation 3) as follows:

CRS(cᵢ,cⱼ)=tf(cᵢ,Cⱼ)*w_{ci}/V(Cᵢ,Cⱼ) Equation (2)

CRS(cⱼ,cᵢ)=tf(cⱼ,Cᵢ)*w_{cj}/V(Cᵢ,Cⱼ) Equation (3)

For Equation (2) and Equation (3), w_{ci} may represent the weight of concept cᵢ in contents Cⱼ, w_{cj} may represent the weight of concept cⱼ in contents Cᵢ, f may represent the term frequency, V(Cᵢ, Cⱼ) may represent vocabulary size of the content Cᵢ and Cⱼ (which represents the total tokens in content Cᵢ and Cⱼ). The values of w_{ci} and w_{cj} may be numerical, and may be determined based on the content information. The values of w_{ci} and w_{cj} may be captured, for example, while applying topic extraction techniques such as Latent Dirichlet Allocation. When a topic modeling technique is applied, topics (i.e., concepts) and associated weights may be ascertained.

If CRS(cᵢ,cⱼ)>CRS(cⱼ,cᵢ) then cᵢ is a pre-requisite of cⱼ Equation (4)

At 606, the content relation learner 128 may determine the concept relevance score using a collaborative approach (e.g., CCRS) based on a number of times users have opted for cᵢ before cⱼ. In this regard, the collaborative approach may represent a numerical value of a number of times users have opted for cᵢ before cⱼ. At 608, the content relation learner 128 may determine the weighted concept relevance score. In FIG. 6, w₁ and w₂ may represent weights applied to the values determined at block 604 and 606, with the default values for w₁ and w₂ being set to 1, and optimal values for w₁ and w₂ being determined, for example, on a trial and experimentation basis.

For example, assuming that concept cᵢ includes “backpropagation” and concept cⱼ includes “gradient descent”, the CRS(cᵢ, cⱼ) and CRS(cⱼ, cᵢ) may be determined by respectively using Equation (2) and Equation (3) above. In this regard, the correct contents Cᵢ and Cⱼ may also be identified for the concepts cᵢ and cⱼ. Further, the term frequency values tf(cᵢ, Cⱼ) and tf(cⱼ, Cᵢ) maybe determined for the concepts cᵢ and cⱼ, and the contents Cᵢ and Cⱼ. Based on these values, CRS(cᵢ, cⱼ) and CRS(cⱼ, cᵢ) may be determine for the example concepts “backpropagation” and “gradient descent”. Similarly CCRS maybe determine for the concepts cᵢ and cⱼ based on a number of times users have opted for cᵢ before cⱼ.

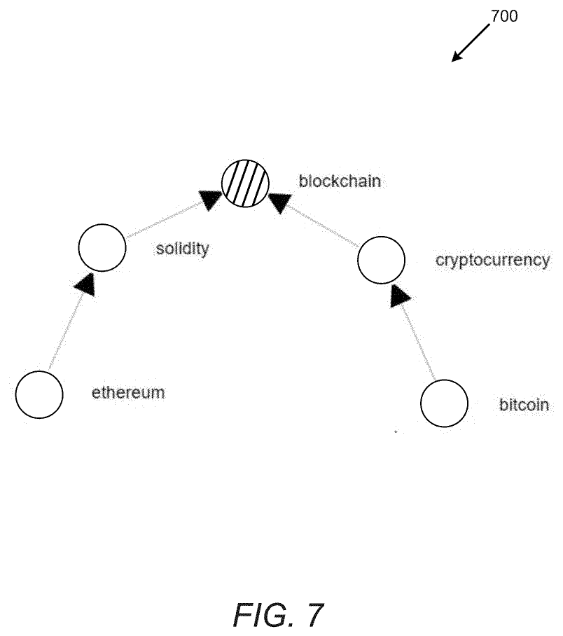

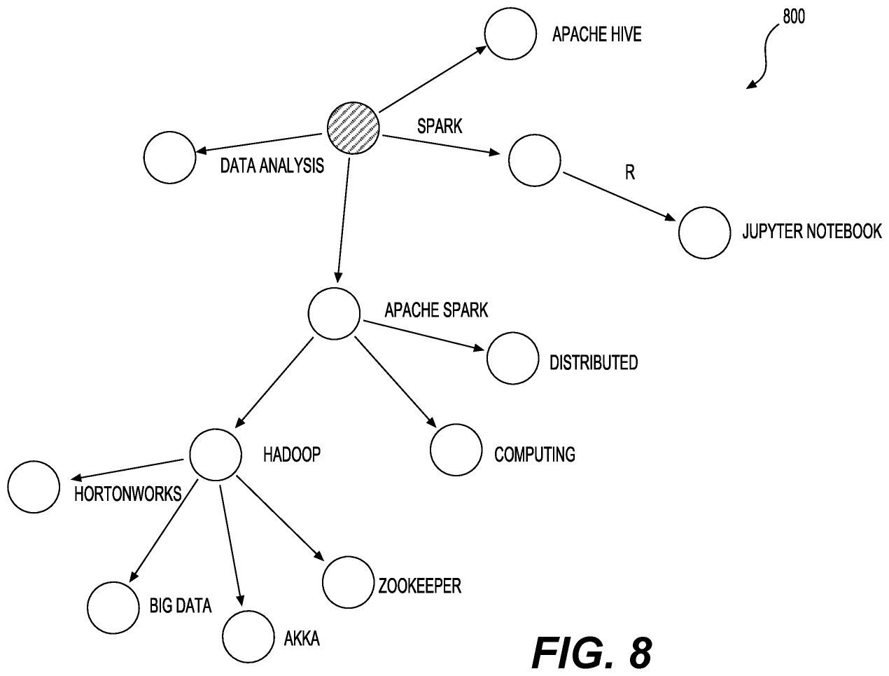

FIG. 7 illustrates a knowledge graph example 700 to illustrate operation of the system 100, according to an example of the present disclosure. FIG. 8 illustrates another knowledge graph example 800 to illustrate operation of the system 100, according to an example of the present disclosure.

Referring to FIGS. 7 and 8, with respect to the knowledge graph generator 122, a knowledge graph (such as the knowledge graphs 700 and 800) may represent a structured graphical representation of a semantic relationship between entities. The knowledge graph generator 122 may ascertain course details such as course content, pre-requisites, and other such information, for example, from a courses platform. Each course content and the pre-requisites (e.g., through relationship learning) may be represented as a set of concepts <cₒ, c₁, c₂, . . . , cₖ>. These concepts may be referred to as entities. The knowledge graph generator 122 may apply a combination of pointwise mutual information and word embedding to extract semantic relationships between concepts. An input to the knowledge graph generator 122 may include a concept representation of each course and its pre-requisites. An output of the knowledge graph generator 122 may include the knowledge graph 124 representing the relationship between various concepts.

In order to generate the knowledge graph 124, the knowledge graph generator 122 may initialize a set of vertices, V as ϕ. In this regard, initially, the number of concepts in vertices set V may be null (ϕ). For each courseᵢ∈courses (e.g., each courseᵢ in a set of courses) the knowledge graph generator 122 may first represent and add each concept cₖ (cₖ∈Cᵢ, where Cᵢ represent a set of concepts of courseᵢ) of the courseᵢ as vertices if cₖ∉V. In this regard, if concept cₖ is not a part of vertices set V, then only this concept may be added as a node in the knowledge graph. This ensures that the same concept should not be added more than once in the knowledge graph. The knowledge graph generator 122 may retrieve the concepts Cₚ<cₒ, c₁, c₂, . . . , cₚ> of a pre-requisite of courseᵢ, and add each concept as vertices if cₚ∉V. In this regard, if pre-requisite concept cₚ is not a part of vertices set V, then only this concept may be added as a node in the knowledge graph. This ensures that the same concept should not be added more than once in the knowledge graph. The knowledge graph generator 122 may add a directed edge cₚ→cₖ if concept_sim(cₚ, cₖ)>threshold. In this regard, if similarity between two concepts is greater than the threshold value, then only will the directed edge be added. This is done to ensure that only relevant concepts should be retained in the knowledge graph. If the in-degree and out-degree of any concept node are zero, then that node may be removed from the knowledge graph (i.e., concept will not be related to any other concepts in the knowledge graph and thus can be removed). For example, for the example of FIG. 7, a directed edge may be added between the “cryptocurrency” concept and the “blockchain” concept, between the “solidity” concept and the “blockchain” concept, etc. In this case, the “bitcoin” concept may represent a pre-requisite for the “cryptocurrency” concept, the “cryptocurrency” concept may represent pre-requisite for the “blockchain” concept, etc. According to another example, for the example of FIG. 8, a directed edge may be added between the “data analysis” concept and the “spark” concept, the “apache hive” concept and the “spark” concept, etc.

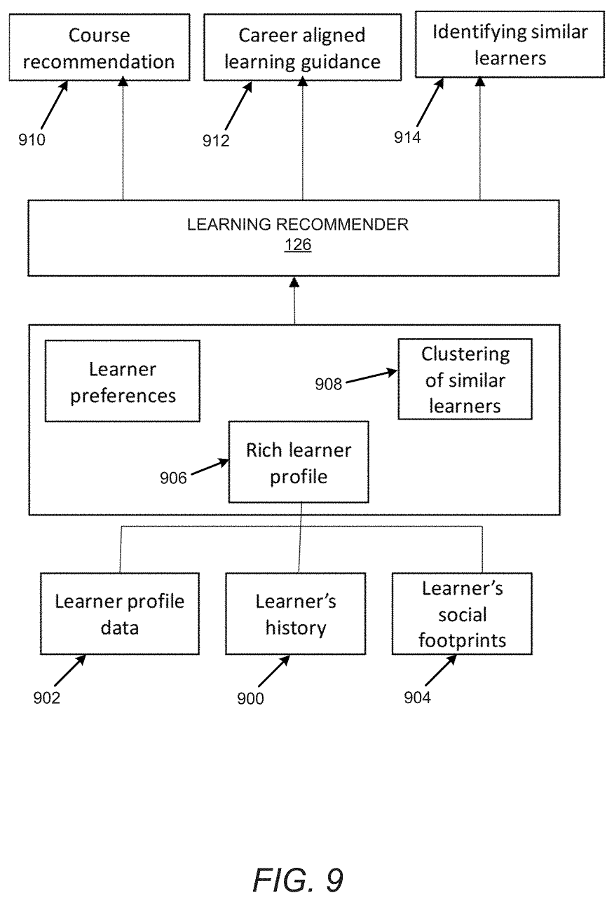

FIG. 9 illustrates a learning recommendation flowchart of the system 100, according to an example of the present disclosure.

Referring to FIG. 9, at 900, the learning recommender 126 may ascertain and learn the past history of the learner 128. For example, the learning recommender 126 may determine courses that have been taken by the learner 128. The learning recommender 126 may determine the past history of similar learners, that may or may not include the learner 128. In this regard, the similar learners may include learners that have similar attributes to the learner 128. At 902, the learner's attributes may be determined from learner profile data. For example, the similar attributes may include education, job title, job location, age, gender, etc. Similar learners may be identified from data collected from internal repositories and external sources. Examples of internal repositories may include company specific repositories, and other such repositories. Examples of external sources may include LINKEDIN, TWITTER, YOUTUBE, and other such sources. The data collected from the external sources may also be used to determine the learner's social footprints at 904. Data from the sources at 900, 902, and 904 may be used to generate a rich learner profile at 906. At 908, the learning recommender 126 may cluster similar users based on aggregate ranking similarity with weights for various sources of the data. The learning recommender 126 may match the learner's goals with the learning content. In this regard, for a given learner, the learning recommender 126 may identify a subset of content matching the learner's goals, and may be non-repetitive, except during revision of the same concept for spaced repetition. The learning recommender 126 may generate a course recommendation at 910, determine career aligned learning guidance at 912, and identify similar learners at 914.

With respect to learning recommendation, the learning recommender 126 may implement collaborative filtering to build a learner's preference model. For example, the collaborative filtering may be implemented on a dataset that includes tuples <learner_id, course_id, rating>, where ratings may be defined on a specified scale (e.g., 1-5). The collaborative filtering technique may build the learner's preference based on the preference of other similar users. In order to assess the effectiveness of the learner's preference model, the learning recommender 126 may determine a mean absolute error (MAE), a root mean square error (RMSE), and/or other such metrics. For example, the mean absolute error may measure the average magnitude of errors in a set of predictions. In this regard the mean absolute error may represent the average over a test sample of absolute differences between prediction and actual observation where all individual differences are assigned equal weights. The root mean square error may represent a quadratic scoring rule that also measures the average magnitude of the error. The root mean square error may represent the square root of the average of squared differences between prediction and actual observation. Thus the mean absolute error, the root mean square error, and other such metrics may measure the accuracy of the learner's preference model.

The learning recommender 126 may utilize a content-based technique that considers the personal characteristics of the learner 128, and course information that the learner 128 has registered for or has completed. Personal characteristics of the learner may include skills (e.g., skill set of the learner 128), geography (e.g., geographical unit of the learner), experience (e.g., years of experience), industry, and other such attributes of the learner exercise. Course information may include course title, course description, course content type, and other such attributes of a course. The personal attributes and the different types of course information may be used as features for deep learning. Depending on the type of data, representation may change as follows. Numerical attributes such as experience, course duration, etc. may be used directly. Unstructured textual information such as course title, course description, profile overview, etc., may be represented as topics. These topics may be represented as features and the weight of the topic may be the feature value. Nominal data such as industry, geography, course content type, etc., may be represented using, for example, one-hot encoding which assigns numerical values to the category. The title and description of the course may be represented as a topics vector using topic modeling techniques such as Latent Dirichlet Allocation. The learning recommender 126 may implement a deep learning model to predict rating. With respect to rating, machine learning and deep learning models may include feature sets that may be denoted as dependent variables. These feature sets may be used to determine the dependent variable (e.g., rating) also denoted label/predicted value. The objective may include predicting the rating (e.g., scale 1-5) that a user is likely to give to a particular course.

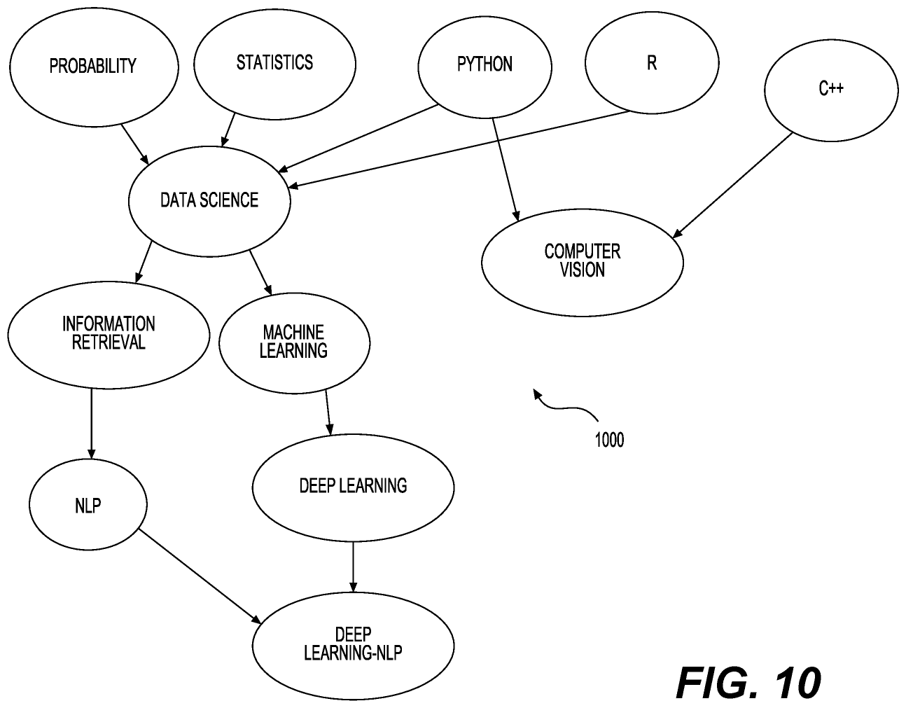

FIG. 10 illustrates a learner's journey map to illustrate operation of the system 100, according to an example of the present disclosure.

Referring to FIG. 10, the learning recommender 126 may map each learner's journey into a concept graph 1000, where the mapped journey may be referred to as a learner journey map. For example, the learner journey map may represent a portion of the knowledge graph of FIG. 10 that includes the highlighted features. In this regard, different highlights may represent different efficiencies of a learner for a particular concept. The learner journey map may be extracted from a knowledge graph such as the knowledge graphs of FIGS. 7 and 8, and the performance on various concepts may also be highlighted. The learner's journey map may be derived from the learner's history. The learner's journey map may be used by the learning recommender 126 for personalized recommendations and suggestions.

As disclosed herein with reference to FIG. 1, the learning goal 132 for the learner 128 may include learning improvement, and the learning recommender 126 may determine, based on the knowledge graph 124, the plurality of ascertained attributes 130, and the learning goal 132 for the learner 128, the concept 134 of the plurality of concepts 106 that matches the learning goal 132 for the learner by identifying, for a specified time period, the concept 134 of the plurality of concepts 106 for which a learner performance score is less than a specified performance threshold, and identifying the concept 134 of the plurality of concepts 106 for which the learner performance score is less than the specified performance threshold as the concept 134 of the plurality of concepts 106 that matches the learning goal 132 for the learner 128. In this regard the learning recommender 126 may store the performance of each learner. The performance of each of the learners may be represented as a score (e.g., 1-5) along with each concept in the form of <learner, [concept, score, timestamp]>. With respect to the score, a learner may take various assessments with respect to different concepts. For example an assessment may pertain to a learner's proficiency with respect to a concept. In this regard, the different assessments may be scored to thus determine an overall score for a concept. With respect to learning improvement, an input to the learning recommender 126 may include a history and performance of the learner 128. An output of the learning recommender 126 may include a list of learning content recommendations. With respect to learning improvement, the learning recommender 126 may identify a set of related concepts Cp<cp₁, cp₂, . . . , cpₘ> over a time period (t) in which the learner's performance score is less than a threshold value (e.g., threshold_value). In this regard the learning recommender 126 may apply a retrieve and rank technique, where the learning content may be ranked based on the semantic relatedness that is measured between the concepts Cp and each course concept C.

With respect to learning improvement, according to an example, referring to FIG. 7, the learner 128 may need improvement with respect to the concept of “blockchain”. In this regard, the learning recommender 126 may recommend that the learner 128 should first take a course related to the “cryptocurrency” concept for learning improvement related to the “blockchain” concept.

As disclosed herein with reference to FIG. 1, the learning goal 132 for the learner 128 may include anticipated learning, and the learning recommender 126 may determine, based on the knowledge graph 124, the plurality of ascertained attributes 130, and the learning goal 132 for the learner 128, the concept 134 of the plurality of concepts 106 that matches the learning goal 132 for the learner 128 by identifying the concept 134 of the plurality of concepts 106 that maps to a current learning status of the learner 128, and identifying, based on the knowledge graph 124, a next concept further to the identified concept of the plurality of concepts 106 that maps to the current learning status of the learner 128. Further, as also disclosed herein with reference to FIG. 1, the learning goal 132 for the learner 128 may include anticipated learning, and the learning recommender 126 may determine, based on the knowledge graph 124, the plurality of ascertained attributes 130, and the learning goal 132 for the learner 128, the concept 134 of the plurality of concepts 106 that matches the learning goal 132 for the learner 128 by identifying the concept 134 of the plurality of concepts 106 that maps to a current learning status of the learner 128, and identifying, based on the knowledge graph 124, a shortest path to a further concept further to the identified concept of the plurality of concepts 106 that maps to the current learning status of the learner 128.

Thus, the learning recommender 126 may generate recommendations with respect to anticipated (e.g., “forward looking”) concepts based on a learner's history. In this regard the learning recommender 126 may generate implicit recommendations that identify the next set of concepts that the learner may be interested in. The learning recommender 126 may utilize the knowledge graph 124 and the learner's history (that will have the concepts covered by the learner). The learning recommender 126 may generate explicit recommendations, where learners may provide the new set of concepts that they are interested in learning. These concepts may be determined when the learner 128 specifies the new set of concepts to the learning recommender 126. In this regard the learning recommender 126 may identify the learning path based on the learner's history and the knowledge graph 124.

With respect to recommendations of anticipated concepts, an input to the learning recommender 126 may include the knowledge graph and the learner's history. An output of the learning recommender 126 may include a list of learning content recommendations. The learning recommender 126 may map the concepts from the learner's history on the knowledge graph 124. For the implicit case, the learning recommender 126 may identify the next set of concepts C_{f}<c_{f1}, c_{f2}, . . . , c_{fm}> based on learner's history and the knowledge graph 124. For the explicit case, the learning recommender 126 may identify the shortest path to reach the target concept from the learner's existing concept by using a shortest path determination process, and a collaborative technique. The path may cover the set of concepts Cₑ<cₑ₁, cₑ₂, . . . , cₑₘ> which the learner may have to take in order to reach the goal. The possible paths may also be reduced by similar learner concepts.

The learning recommender 126 may apply a retrieve and rank approach, where the learning content may be ranked based on the semantic relatedness that is measured between the concepts C_{f}/Cₑ and each course concept C. For example, the next set of concepts for which the learner needs improvement may be identified. In this regard, the relevant content may be identified for each concept, and the content may be ranked based on the semantic relatedness that is measured between the concepts C_{f}/Cₑ and each course concept C.

Thus, with respect to recommendations of anticipated concepts, the learning recommender 126 may identify paths from the learner's existing concept to a target concept. These identified paths may cover a set of concepts. The learning recommender 126 may interactively query the learner 128 to determine whether the learner is interested in learning some of the intermediate path/concepts, or not. The learning recommender 126 may provide only selective concepts derived from other similar learners.

With respect to recommendations of anticipated concepts, according to an example, referring to FIG. 7, assuming that the learner 128 has learned the concepts of “bitcoin” and “solidity”, for the implicit case, the next concept further to “bitcoin” may include “cryptocurrency”, and the next concept further to “solidity” may include “blockchain”. For the explicit case, referring to FIG. 8, assuming that the learner 128 has learned the concept of “zookeeper”, for the explicit case, the shortest path to “apache spark” may include “hadoop”.

With respect to learner to learner similarity, the learning recommender 126 may determine similarity between learners based on similarity between projects completed by learners. In this regard the learning recommender 126 may implement a content matching technique such as “Latent Dirichlet Allocation”, or other such techniques, to determine similarity between projects. The learning recommender 126 may determine similarity between profile characteristics such as profile overview and semantic relatedness between skills/concepts. The learning recommender 126 may determine similarity between the description of courses that learners have enrolled in.

With respect to learner to learner similarity, and input to the learning recommender 126 may include a learner's profile information. An output of the learning recommender 126 may include a matrix representing the similarity score between learners. With respect to learner to learner similarity, the learning recommender 126 may initialize all of the diagonal elements of the matrix to 1, and set the rest of the elements to 0. For i∈{1, . . . , N}, the learning recommender 126 may apply Latent Dirichlet Allocation, or other such techniques, on the description of projects completed by learners lᵢ and lⱼ. The learning recommender 126 may determine the cosine similarity between project description topics vector of lᵢ and lⱼ as follows:

$$cos\_sim ( {PD}_{{l}_{i}} , {PD}_{{l}_{j}} ) = \frac{P {{D}^{->}}_{{l}_{i}} \cdot P {{D}^{->}}_{{l}_{j}}}{‖ {PD}_{{l}_{i}} ‖ \cdot ‖ {PD}_{{l}_{j}} ‖} \qquad Equation ( 5 )$$

For Equation (5), PDₗ_{ᵢ} may represent the scalar value (or norm) of a project description for learner lᵢ, PD̅ₗ_{ᵢ} may represent a project description vector for learner lᵢ, PDₗ_{ⱼ} may represent the scalar value (or norm) of a project description for learner lⱼ, and PD̅ₗ_{ⱼ} may represent a project description vector for learner lⱼ.

The learning recommender 126 may apply Latent Dirichlet Allocation, or other such techniques, on the profile overview of learners lᵢ and lⱼ. The learning recommender 126 may determine the cosine similarity between profile overview topics vector of lᵢ and lⱼ as follows:

$$cos\_sim ( {PO}_{{l}_{i}} , {PO}_{{l}_{j}} ) = \frac{P {{O}^{->}}_{{l}_{i}} \cdot P {{O}^{->}}_{{l}_{j}}}{‖ {PO}_{{l}_{i}} ‖ \cdot ‖ {PO}_{{l}_{j}} ‖} \qquad Equation ( 6 )$$

For Equation (6), POₗ_{ᵢ} may represent the scalar value (or norm) of profile overview for learner lᵢ, PŌₗ_{ᵢ} may represent profile overview vector for learner lᵢ, POₗ_{ⱼ} may represent the scalar value (or norm) of profile overview for learner lⱼ, and PŌₗ_{ⱼ} may represent profile overview vector for learner lⱼ.

The learning recommender 126 may determine the skills/concepts similarity between learners lᵢ and lⱼ as follows:

Skill_similarity(Sₗ_{ᵢ},Sₗ_{ⱼ})=sim_dist(Sₗ_{ᵢ},Sₗ_{ⱼ}) Equation (7)

For Equation (7), Sₗ_{ᵢ} and Sₗ_{ⱼ} may represent the set of skills possessed by learners lᵢ and lⱼ respectively. With respect to “sim_dist(Sₗ_{ᵢ}, Sₗ_{ⱼ})”, assuming that Sₗ_{ᵢ} includes {S1 S2 S3} and Sₗ_{ⱼ} includes {S4 S5 S6}, the “sim_dist(Sₗ_{ᵢ}, Sₗ_{ⱼ})” may be determined as a cross product of the contents of Sₗ_{ᵢ} and Sₗ_{ⱼ} as follows: sim_dist(s1, s4)+sim_dist(s1, s5)+sim_dist(s1, s6)+ . . . sim_dist(s2, s4), etc., being derived from Equation (1).

The learning recommender 126 may apply Latent Dirichlet Allocation, or other such techniques, on the description of courses enrolled by learners lᵢ and lⱼ. The learning recommender 126 may determine the cosine similarity between course description topics vector of lᵢ and lⱼ as follows:

$$cos\_sim ( {CD}_{{l}_{i}} , {CD}_{{l}_{j}} ) = \frac{C {{D}^{->}}_{{l}_{i}} \cdot C {{D}^{->}}_{{l}_{j}}}{‖ {CD}_{{l}_{i}} ‖ \cdot ‖ {CD}_{{l}_{j}} ‖} \qquad Equation ( 8 )$$

For Equation (8), CDₗ_{ᵢ} may represent the scalar value (or norm) of a course description for learner lᵢ, CD̅ₗ_{ᵢ} may represent course description vector for learner lᵢ, CDₗ_{ⱼ} may represent the scalar value (or norm) of a course description for learner lⱼ, and CD̅ₗ_{ⱼ} may represent course description vector for learner lⱼ.

The learning recommender 126 may determine the learner to learner similarity score as follows:

$${L}_{ij} = ( cos\_sim ( {PD}_{{l}_{i}} , {PD}_{{l}_{j}} ) + cos\_sim ( {PO}_{{l}_{i}} , {PO}_{{l}_{j}} ) + Skill\_similarity ( {S}_{{l}_{i}} , {S}_{{l}_{j}} ) + cos\_sim ( {CD}_{{l}_{i}} , {CD}_{{l}_{j}} ) / 4 \qquad Equation ( 9 )$$

As disclosed herein with respect to FIG. 1, according to examples described herein, the learning recommender 126 may identify a portion of the concept 134 of the plurality of concepts 106 that matches the learning goal for the learner 128 by dividing the concept into a plurality of frames, and performing a maximum sum sub-sequence process to identify a relevant frame of the plurality of frames that matches the learning goal 132 for the learner 128. In this regard, with respect to micro-learning content, as the entire learning content may not be relevant to the learner 128, the learning recommender 126 may implement micro-based learning where only a portion of relevant content may be extracted from the type of content, such as video, audio, etc. In this regard, video may be divided into several frames F<f₁, f₂, . . . , fₙ>, where F may represent all of the frames, and f₁, f₂, etc., may represent each individual frame. Each frame of the video may represent certain concepts. The learning recommender 126 may implement a maximum sum sub-sequence process to determine the relevant set of frames. With respect to the sub-sequence process, assuming that frames f₁, f₂, f₃, and f₄, respectively include concepts (C1, C2), C3, C4, and C5, in this regard, the maximum sum sub-sequence process may be used to determine the relevant set of frames and the appropriate learning content within those frames. Assuming that a learner would like to learn concepts C1 and C3, in this regard the concepts C1 and C3 may be matched with each of the frames and sequences (e.g., f₁, f₂, then f₁, f₂, f₃, then f₁, f₂, f₃, f₄, then f₂, f₃, etc.), where frames f₁ and then f₂ include the maximum sub-sequence (e.g., the maximum overlap).

With respect to micro-learning content, an input to the learning recommender 126 may include video content and preferences of the learner 128. An output of the learning recommender 126 may include relevant micro content. The learning recommender 126 may determine semantic similarity between the concepts that the learner 128 is interested in with the concepts of each possible set of subsequence frame. Further, the subsequence of the frames which have maximum similarity value may be considered.

The learning recommender 126 may determine the dynamic context of the learner 128, for example, through sensors, such as the sensor 136, in the learner's mobile phone and/or other sensors that may be used to enrich the recommendation. For example, with respect to location, if the learner 128 is waiting in a long retail shop queue (e.g., an expected time as disclosed herein), then relatively small five minute videos may be preferred over a long book. Likewise artificial intelligence in retail may be a good recommendation versus artificial intelligence applied to banking. According to another example, with respect to time, the learner 128 may have preferences on times of day that are preferred for learning and media formats at a specified time. According to another example, with respect to whether the learner 128 is stationary or on the move, audio lessons may be preferred when driving a car while video may be preferred on a metro train or while at home. According to another example, with respect to emotions, a focused state versus a distracted state may encourage more or less guidance. Thus the learning recommender 126 may capture the pattern/preferences of the learner as well as other similar learners over a period using a priori-based pattern mining techniques to capture the pattern among learners for different contexts.

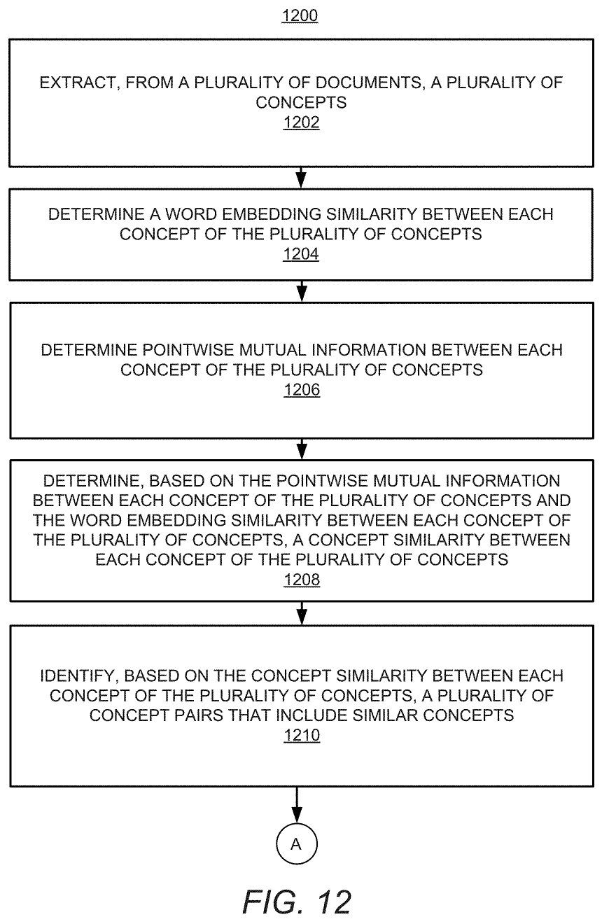

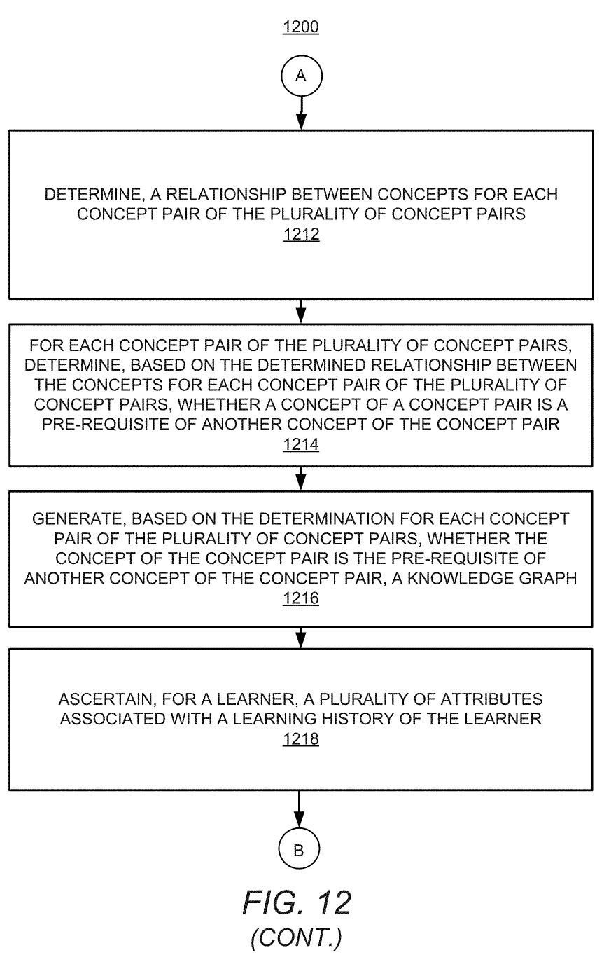

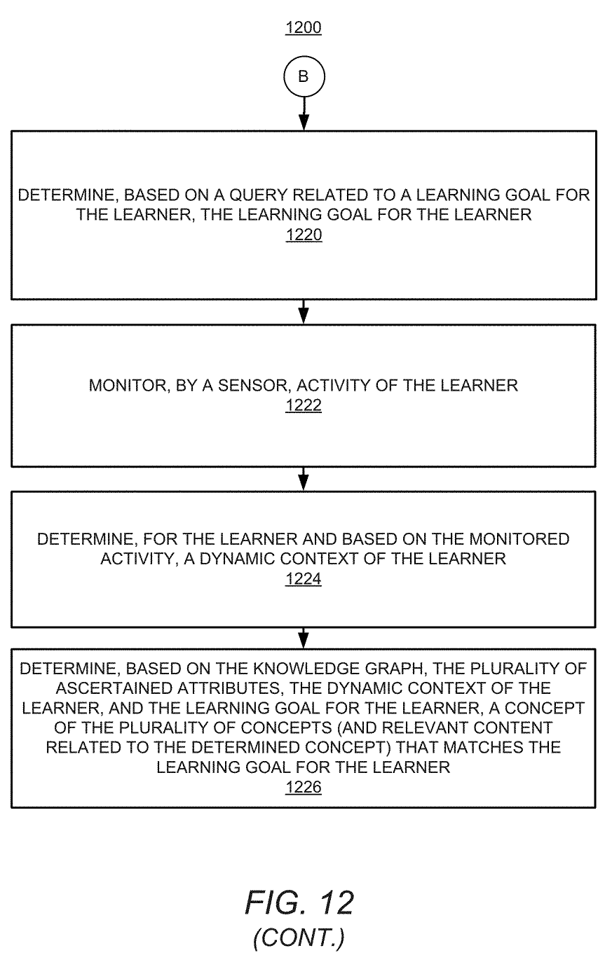

FIGS. 11-13 respectively illustrate a block diagram 1100, a flowchart of a method 1200, and a further block diagram 1300 for a knowledge graph based learning content generation, according to examples. The block diagram 1100, the method 1200, and the block diagram 1300 may be implemented on the system 100 described above with reference to FIG. 1 by way of example and not limitation. The block diagram 1100, the method 1200, and the block diagram 1300 may be practiced in other systems. In addition to showing the block diagram 1100, FIG. 11 shows hardware of the system 100 that may execute the instructions of the block diagram 1100. The hardware may include a processor 1102, and a memory 1104 storing machine readable instructions that when executed by the processor cause the processor to perform the instructions of the block diagram 1100. The memory 1104 may represent a non-transitory computer readable medium. FIG. 12 may represent a method for implementing a knowledge graph based learning content generation, and the steps of the method. FIG. 13 may represent a non-transitory computer readable medium 1302 having stored thereon machine readable instructions to provide a knowledge graph based learning content generation. The machine readable instructions, when executed, cause a processor 1304 to perform the instructions of the block diagram 1300 also shown in FIG. 13.

The processor 1102 of FIG. 11 and/or the processor 1304 of FIG. 13 may include a single or multiple processors or other hardware processing circuit, to execute the methods, functions and other processes described herein. These methods, functions and other processes may be embodied as machine readable instructions stored on a computer readable medium, which may be non-transitory (e.g., the non-transitory computer readable medium 1302 of FIG. 13), such as hardware storage devices (e.g., RAM (random access memory), ROM (read only memory), EPROM (erasable, programmable ROM), EEPROM (electrically erasable, programmable ROM), hard drives, and flash memory). The memory 1104 may include a RAM, where the machine readable instructions and data for a processor may reside during runtime.

Referring to FIGS. 1-11, and particularly to the block diagram 1100 shown in FIG. 11, the memory 1104 may include instructions 1106 to ascertain a plurality of documents.

The processor 1102 may fetch, decode, and execute the instructions 1108 to extract, from the plurality of documents 104, a plurality of topics.

The processor 1102 may fetch, decode, and execute the instructions 1110 to represent the plurality of topics as a plurality of concepts 106.

The processor 1102 may fetch, decode, and execute the instructions 1112 to determine a word embedding similarity 110 between each concept of the plurality of concepts 106.

The processor 1102 may fetch, decode, and execute the instructions 1114 to determine pointwise mutual information 114 between each concept of the plurality of concepts 106.

The processor 1102 may fetch, decode, and execute the instructions 1116 to determine, based on the pointwise mutual information 114 between each concept of the plurality of concepts 106 and the word embedding similarity 110 between each concept of the plurality of concepts 106, a concept similarity 116 between each concept of the plurality of concepts 106.

The processor 1102 may fetch, decode, and execute the instructions 1118 to identify, based on the concept similarity 116 between each concept of the plurality of concepts 106, a plurality of concept pairs 118 that include similar concepts.

The processor 1102 may fetch, decode, and execute the instructions 1120 to determine a relationship between concepts for each concept pair of the plurality of concept pairs 118.

The processor 1102 may fetch, decode, and execute the instructions 1122 to, for each concept pair of the plurality of concept pairs 118, determine, based on the determined relationship between the concepts for each concept pair of the plurality of concept pairs 118, whether a concept of a concept pair is a pre-requisite of another concept of the concept pair.

The processor 1102 may fetch, decode, and execute the instructions 1124 to generate, based on the determination for each concept pair of the plurality of concept pairs 118, whether the concept of the concept pair is the pre-requisite of another concept of the concept pair, a knowledge graph 124.

The processor 1102 may fetch, decode, and execute the instructions 1126 to ascertain, for a learner 128, a plurality of attributes 130 associated with a learning history of the learner 128.

The processor 1102 may fetch, decode, and execute the instructions 1128 to determine, based on a query related to a learning goal 132 for the learner 128, the learning goal 132 for the learner 128.

The processor 1102 may fetch, decode, and execute the instructions 1130 to determine, based on the knowledge graph 124, the plurality of ascertained attributes 130, and the learning goal 132 for the learner 128, a concept of the plurality of concepts 106 that matches the learning goal 132 for the learner 128.

Referring to FIGS. 1-10 and 12, and particularly FIG. 12, for the method 1200, at block 1202, the method may include extracting, by at least one processor, from a plurality of documents 104, a plurality of concepts 106.

At block 1204, the method may include determining, by the at least one processor, a word embedding similarity 110 between each concept of the plurality of concepts 106.

At block 1206, the method may include determining, by the at least one processor, pointwise mutual information 114 between each concept of the plurality of concepts 106.

At block 1208, the method may include determining, by the at least one processor, based on the pointwise mutual information 114 between each concept of the plurality of concepts 106 and the word embedding similarity 110 between each concept of the plurality of concepts 106, a concept similarity 116 between each concept of the plurality of concepts 106.

At block 1210, the method may include identifying, by the at least one processor, based on the concept similarity 116 between each concept of the plurality of concepts 106, a plurality of concept pairs 118 that include similar concepts 106.

At block 1212, the method may include determining, by the at least one processor, a relationship between concepts for each concept pair of the plurality of concept pairs 118.

At block 1214, the method may include, for each concept pair of the plurality of concept pairs 118, determining, by the at least one processor, based on the determined relationship between the concepts for each concept pair of the plurality of concept pairs 118, whether a concept of a concept pair is a pre-requisite of another concept of the concept pair.

At block 1216, the method may include generating, by the at least one processor, based on the determination for each concept pair of the plurality of concept pairs 118, whether the concept of the concept pair is the pre-requisite of another concept of the concept pair, a knowledge graph 124.

At block 1218, the method may include ascertaining, by the at least one processor, for a learner 128, a plurality of attributes 130 associated with a learning history of the learner 128.

At block 1220, the method may include determining, by the at least one processor, based on a query related to a learning goal 132 for the learner 128, the learning goal 132 for the learner 128.

At block 1222, the method may include monitoring, by a sensor, activity of the learner 128.

At block 1224, the method may include determining, by the at least one processor, for the learner 128 and based on the monitored activity, a dynamic context of the learner 128.

At block 1226, the method may include determining, by the at least one processor, based on the knowledge graph 124, the plurality of ascertained attributes 130, the dynamic context of the learner 128, and the learning goal 132 for the learner 128, a concept of the plurality of concepts 106 that matches the learning goal 132 for the learner 128.

Referring to FIGS. 1-10 and 13, and particularly FIG. 13, for the block diagram 1300, the non-transitory computer readable medium 1302 may include instructions 1306 to extract, from a plurality of documents 104, a plurality of concepts 106.

The processor 1304 may fetch, decode, and execute the instructions 1308 to determine a word embedding similarity 110 between each concept of the plurality of concepts 106.

The processor 1304 may fetch, decode, and execute the instructions 1310 to determine pointwise mutual information 114 between each concept of the plurality of concepts 106.

The processor 1304 may fetch, decode, and execute the instructions 1312 to determine, based on the pointwise mutual information 114 between each concept of the plurality of concepts 106 and the word embedding similarity 110 between each concept of the plurality of concepts 106, a concept similarity 116 between each concept of the plurality of concepts 106.

The processor 1304 may fetch, decode, and execute the instructions 1314 to identify, based on the concept similarity 116 between each concept of the plurality of concepts 106, a plurality of concept pairs 118 that include similar concepts 106.

The processor 1304 may fetch, decode, and execute the instructions 1316 to determine, a relationship between concepts for each concept pair of the plurality of concept pairs 118.

The processor 1304 may fetch, decode, and execute the instructions 1318, for each concept pair of the plurality of concept pairs 118, to determine, based on the determined relationship between the concepts for each concept pair of the plurality of concept pairs 118, whether a concept of a concept pair is a pre-requisite of another concept of the concept pair.

The processor 1304 may fetch, decode, and execute the instructions 1320 to generate, based on the determination for each concept pair of the plurality of concept pairs 118, whether the concept of the concept pair is the pre-requisite of another concept of the concept pair, a knowledge graph 124.

The processor 1304 may fetch, decode, and execute the instructions 1322 to ascertain, for a learner 128, a plurality of attributes 130 associated with a learning history of the learner 128.

The processor 1304 may fetch, decode, and execute the instructions 1324 ascertain a learning goal 132 for the learner 128.

The processor 1304 may fetch, decode, and execute the instructions 1326 monitor, by a mobile communication device associated with the learner 128, activity of the learner 128, wherein the activity of the learner 128 includes at least one of an expected time at a specified location and/or an indication of movement of the learner 128.

The processor 1304 may fetch, decode, and execute the instructions 1328 determine, for the learner 128 and based on the monitored activity, a dynamic context of the learner 128.

The processor 1304 may fetch, decode, and execute the instructions 1330 determine, based on the knowledge graph 124, the plurality of ascertained attributes 130, the dynamic context of the learner 128, and the learning goal 132 for the learner 128, a concept of the plurality of concepts 106 that matches the learning goal 132 for the learner 128.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A system comprising:
a concept extractor, executed by at least one hardware processor, to
ascertain a plurality of documents,
extract, from the plurality of documents, a plurality of topics, and
represent the plurality of topics as a plurality of concepts;
a word embedding analyzer, executed by the at least one hardware processor, to
determine a word embedding similarity between each concept of the plurality of concepts;
a concept similarity analyzer, executed by the at least one hardware processor, to
determine pointwise mutual information between each concept of the plurality of concepts,
determine, based on the pointwise mutual information between each concept of the plurality of concepts and the word embedding similarity between each concept of the plurality of concepts, a concept similarity between each concept of the plurality of concepts, and
identify, based on the concept similarity between each concept of the plurality of concepts, a plurality of concept pairs that include similar concepts;
a concept relation learner, executed by the at least one hardware processor, to
determine a relationship between concepts for each concept pair of the plurality of concept pairs, and
for each concept pair of the plurality of concept pairs,
determine, based on the determined relationship between the concepts for each concept pair of the plurality of concept pairs, whether a concept of a concept pair is a pre-requisite of another concept of the concept pair;
a knowledge graph generator, executed by the at least one hardware processor, to
generate, based on the determination for each concept pair of the plurality of concept pairs, whether the concept of the concept pair is the pre-requisite of another concept of the concept pair, a knowledge graph; and
a learning recommender, executed by the at least one hardware processor, to
ascertain, for a learner, a plurality of attributes associated with a learning history of the learner,
determine, based on a query related to a learning goal for the learner, the learning goal for the learner, and
determine, based on the knowledge graph, the plurality of ascertained attributes, and the learning goal for the learner, a concept of the plurality of concepts that matches the learning goal for the learner.

2. The system according to claim 1, wherein the word embedding analyzer is executed by the at least one hardware processor to determine the word embedding similarity between each concept of the plurality of concepts by
determining a cosine similarity between each concept of the plurality of concepts.

3. The system according to claim 1, wherein the concept similarity analyzer is executed by the at least one hardware processor to identify, based on the concept similarity between each concept of the plurality of concepts, the plurality of concept pairs that include similar concepts by
identifying the plurality of concept pairs that include a pointwise mutual information score and a word embedding similarity score that exceeds a predetermined concept similarity threshold.

4. The system according to claim 1, wherein the concept relation learner is executed by the at least one hardware processor to determine, based on the determined relationship between the concepts for each concept pair of the plurality of concept pairs, whether the concept of the concept pair is the pre-requisite of another concept of the concept pair by
determining a relevance score of the concept of the concept pair to contents associated with the another concept of the concept pair,
determining another relevance score of the another concept of the concept pair to contents associated with the concept of the concept pair, and
comparing the relevance scores to determine whether the concept of the concept pair is the pre-requisite of the another concept of the concept pair.

5. The system according to claim 1, wherein the concept relation learner is executed by the at least one hardware processor to determine, based on the determined relationship between the concepts for each concept pair of the plurality of concept pairs, whether the concept of the concept pair is the pre-requisite of another concept of the concept pair by
determining a number of times that the concept of the concept pair is selected before the another concept of the concept pair, and
based on a determination that the number of times that the concept of the concept pair is selected before the another concept of the concept pair exceeds a specified threshold, designating the concept of the concept pair as the pre-requisite of the another concept of the concept pair.

6. The system according to claim 1, wherein the knowledge graph generator is executed by the at least one hardware processor to generate, based on the determination for each concept pair of the plurality of concept pairs, whether the concept of the concept pair is the pre-requisite of another concept of the concept pair, the knowledge graph by
for each course of a plurality of courses,
adding each concept of the course of the plurality of courses as vertices of the knowledge graph,
adding each pre-requisite concept of the course of the plurality of courses as further vertices of the knowledge graph,
determining whether a concept similarity of a concept relative to a pre-requisite concept exceeds a specified concept similarity threshold, and
based on a determination that the concept similarity of the concept relative to the pre-requisite concept exceeds the specified concept similarity threshold, adding a directed edge from the pre-requisite concept to the concept associated with the pre-requisite concept.

7. The system according to claim 1, wherein the plurality of attributes include courses that the learner has taken.

8. The system according to claim 1, wherein the learning goal for the learner includes learning improvement, and wherein the learning recommender is executed by the at least one hardware processor to determine, based on the knowledge graph, the plurality of ascertained attributes, and the learning goal for the learner, the concept of the plurality of concepts that matches the learning goal for the learner by
identifying, for a specified time period, the concept of the plurality of concepts for which a learner performance score is less than a specified performance threshold, and
identifying the concept of the plurality of concepts for which the learner performance score is less than the specified performance threshold as the concept of the plurality of concepts that matches the learning goal for the learner.

9. The system according to claim 1, wherein the learning goal for the learner includes anticipated learning, and wherein the learning recommender is executed by the at least one hardware processor to determine, based on the knowledge graph, the plurality of ascertained attributes, and the learning goal for the learner, the concept of the plurality of concepts that matches the learning goal for the learner by
identifying the concept of the plurality of concepts that maps to a current learning status of the learner, and
identifying, based on the knowledge graph, a next concept further to the identified concept of the plurality of concepts that maps to the current learning status of the learner.

10. The system according to claim 1, wherein the learning goal for the learner includes anticipated learning, and wherein the learning recommender is executed by the at least one hardware processor to determine, based on the knowledge graph, the plurality of ascertained attributes, and the learning goal for the learner, the concept of the plurality of concepts that matches the learning goal for the learner by
identifying the concept of the plurality of concepts that maps to a current learning status of the learner, and
identifying, based on the knowledge graph, a shortest path to a further concept further to the identified concept of the plurality of concepts that maps to the current learning status of the learner.

11. The system according to claim 1, wherein the learning recommender is executed by the at least one hardware processor to determine a learner to learner similarity between the learner and another learner by
applying Latent Dirichlet Allocation to a description of courses completed by the learner and the another learner to generate description topics vectors,
determining a cosine similarity between the description topics vectors of the learner and the another learner,
applying Latent Dirichlet Allocation to a profile overview of the learner and the another learner to generate profile overview topics vectors,
determining a cosine similarity between the profile overview topics vectors of the learner and the another learner,
determining a skills and concepts similarity between the learner and the another learner,
applying Latent Dirichlet Allocation to a description of courses enrolled by the learner and the another learner to generate course description topics vectors,
determining a cosine similarity between the course description topics vectors of the learner and the another learner, and
determining a learner to learner similarity score as a function of the determined cosine similarity between the description topics vectors of the learner and the another learner, the determined cosine similarity between the profile overview topics vectors of the learner and the another learner, the determined skills and concepts similarity between the learner and the another learner, and the determined cosine similarity between the course description topics vectors of the learner and the another learner.

12. The system according to claim 1, wherein the learning recommender is executed by the at least one hardware processor to identify a portion of the concept of the plurality of concepts that matches the learning goal for the learner by
dividing the concept into a plurality of frames, and
performing a maximum sum sub-sequence process to identify a relevant frame of the plurality of frames that matches the learning goal for the learner.

13. The system according to claim 1, further comprising:
a sensor to monitor activity of the learner, wherein the learning recommender is executed by the at least one hardware processor to
determine, for the learner and based on the monitored activity, a dynamic context of the learner, and
determine, based on the knowledge graph, the plurality of ascertained attributes, the determined dynamic context of the learner, and the learning goal for the learner, the concept of the plurality of concepts that matches the learning goal for the learner.

14. A computer implemented method comprising:
extracting, by at least one processor, from a plurality of documents, a plurality of concepts;
determining, by the at least one processor, a word embedding similarity between each concept of the plurality of concepts;
determining, by the at least one processor, pointwise mutual information between each concept of the plurality of concepts;
determining, by the at least one processor, based on the pointwise mutual information between each concept of the plurality of concepts and the word embedding similarity between each concept of the plurality of concepts, a concept similarity between each concept of the plurality of concepts;
identifying, by the at least one processor, based on the concept similarity between each concept of the plurality of concepts, a plurality of concept pairs that include similar concepts;
determining, by the at least one processor, a relationship between concepts for each concept pair of the plurality of concept pairs;
for each concept pair of the plurality of concept pairs,
determining, by the at least one processor, based on the determined relationship between the concepts for each concept pair of the plurality of concept pairs, whether a concept of a concept pair is a pre-requisite of another concept of the concept pair;
generating, by the at least one processor, based on the determination for each concept pair of the plurality of concept pairs, whether the concept of the concept pair is the pre-requisite of another concept of the concept pair, a knowledge graph;
ascertaining, by the at least one processor, for a learner, a plurality of attributes associated with a learning history of the learner;
determining, by the at least one processor, based on a query related to a learning goal for the learner, the learning goal for the learner;
monitoring, by a sensor, activity of the learner;
determining, by the at least one processor, for the learner and based on the monitored activity, a dynamic context of the learner; and
determining, by the at least one processor, based on the knowledge graph, the plurality of ascertained attributes, the dynamic context of the learner, and the learning goal for the learner, a concept of the plurality of concepts that matches the learning goal for the learner.

15. The method according to claim 14, wherein monitoring, by the sensor, the activity of the learner further comprises:
monitoring, by the sensor that includes a location sensor, the activity of the learner that includes an expected time at a specified location; and
determining, by the at least one processor, based on the knowledge graph, the plurality of ascertained attributes, the dynamic context of the learner that includes the expected time at the specified location, and the learning goal for the learner, the concept of the plurality of concepts that matches the learning goal for the learner within the expected time at the specified location.

16. The method according to claim 14, wherein monitoring, by the sensor, the activity of the learner further comprises:
monitoring, by the sensor that includes a time sensor, the activity of the learner at a specified time; and
determining, by the at least one processor, based on the knowledge graph, the plurality of ascertained attributes, the dynamic context of the learner that includes the activity of the learner at the specified time, and the learning goal for the learner, the concept of the plurality of concepts that matches the learning goal for the learner at the specified time.

17. The method according to claim 14, wherein monitoring, by the sensor, the activity of the learner further comprises:
monitoring, by the sensor that includes a movement sensor, the activity of the learner that includes an indication of movement of the learner; and
determining, by the at least one processor, based on the knowledge graph, the plurality of ascertained attributes, the dynamic context of the learner that includes the activity of the learner that includes the indication of movement of the learner, and the learning goal for the learner, the concept of the plurality of concepts that matches the learning goal for the learner during the movement of the learner.

18. A non-transitory computer readable medium having stored thereon machine readable instructions, the machine readable instructions, when executed, cause at least one hardware processor to:
extract, from a plurality of documents, a plurality of concepts;
determine a word embedding similarity between each concept of the plurality of concepts;
determine pointwise mutual information between each concept of the plurality of concepts;
determine, based on the pointwise mutual information between each concept of the plurality of concepts and the word embedding similarity between each concept of the plurality of concepts, a concept similarity between each concept of the plurality of concepts;
identify, based on the concept similarity between each concept of the plurality of concepts, a plurality of concept pairs that include similar concepts;
determine, a relationship between concepts for each concept pair of the plurality of concept pairs;
for each concept pair of the plurality of concept pairs,
determine, based on the determined relationship between the concepts for each concept pair of the plurality of concept pairs, whether a concept of a concept pair is a pre-requisite of another concept of the concept pair;
generate, based on the determination for each concept pair of the plurality of concept pairs, whether the concept of the concept pair is the pre-requisite of another concept of the concept pair, a knowledge graph;
ascertain, for a learner, a plurality of attributes associated with a learning history of the learner;
ascertain a learning goal for the learner;
monitor, by a mobile communication device associated with the learner, activity of the learner, wherein the activity of the learner includes at least one of:
an expected time at a specified location; or
an indication of movement of the learner;
determine, for the learner and based on the monitored activity, a dynamic context of the learner; and
determine, based on the knowledge graph, the plurality of ascertained attributes, the dynamic context of the learner, and the learning goal for the learner, a concept of the plurality of concepts that matches the learning goal for the learner.

19. The non-transitory computer readable medium according to claim 18, wherein for the activity of the learner that includes the expected time at the specified location, the machine readable instructions to determine, based on the knowledge graph, the plurality of ascertained attributes, the dynamic context of the learner, and the learning goal for the learner, the concept of the plurality of concepts that matches the learning goal for the learner, when executed by the at least one hardware processor, further cause the at least one hardware processor to:
determine, based on the knowledge graph, the plurality of ascertained attributes, the dynamic context of the learner that includes the expected time at the specified location, and the learning goal for the learner, the concept of the plurality of concepts that matches the learning goal for the learner during the movement of the learner.

20. The non-transitory computer readable medium according to claim 18, wherein for the activity of the learner that includes the indication of movement of the learner, the machine readable instructions to determine, based on the knowledge graph, the plurality of ascertained attributes, the dynamic context of the learner, and the learning goal for the learner, the concept of the plurality of concepts that matches the learning goal for the learner, when executed by the at least one hardware processor, further cause the at least one hardware processor to:
determine, based on the knowledge graph, the plurality of ascertained attributes, the dynamic context of the learner that includes the indication of movement of the learner, and the learning goal for the learner, the concept of the plurality of concepts that matches the learning goal for the learner during the movement of the learner.
